(19) United States
(12) Patent Application Publication
(10) Pub. No.: US 2002/0107916 A1
(43) Pub. Date: Aug. 8, 2002

(54) Inside-vehicle information communication method, inside-vehicle information communication apparatus, inside-vehicle information communication system, inside-vehicle information communication program, recording medium storing the inside-vehicle information communication program, vehicle-provided communication network system, and information recording medium issuing apparatus

(76) Inventors: Yukako Nii, Nara-shi (JP); Syoichiro Yoshiura, Ikoma-gun (JP); Tsutomu Yoshimoto, Yamatotakada-shi (JP)

Correspondence Address: NIXON & VANDERHYE P.C., 1100 North Glebe Road, 8th Floor, Arlington, VA, 22201-4714, US

(21) Appl. No.: 10/006,246

(22) Filed: Dec. 10, 2001

(30) Foreign Application Priority Data
Feb. 5, 2001 (JP) 2001-28384
Oct. 31, 2001 (JP) 2001-335259

(51) Int. Cl. G06F 15/16

(52) U.S. Cl. 709/203

(57) ABSTRACT

An inside-vehicle information communication method, includes the steps of: causing a server, provided in a vehicle, to output a request for vehicle using right information, possessed by a user, to an electric device possessed by the user, upon receipt of a request for connection outputted by the electric device; causing the server to receive the vehicle using right information, outputted from the electric device upon receipt of the request for the vehicle using right information; and causing the server to confirm whether the electric device has the using right of the vehicle or not, in accordance with the vehicle using right information, and to allow an electric device having the using right to be connected to the server. Thus, the server can be connected to only the electric device having the using right, so that it is possible for users to receive information communication service by performing a simple procedure.

### FIELD OF THE INVENTION

In a communication network system, the present invention specifically relates to an inside-vehicle information communication method, an inside-vehicle information communication apparatus, an inside-vehicle information communication system, an inside-vehicle information communication program, a recording medium storing the inside-vehicle information communication program, a vehicle-provided communication network system, and an information recording medium issuing apparatus, which are provided in a vehicle.

### BACKGROUND OF THE INVENTION

As information communication service which can be shared at a fixed place, for example, a printer (for example, communication by means of a facsimile) installed in a convenience store is used. However, when it is impossible to stay at a fixed place due to time restriction etc., it is difficult to use the information communication service. Further, when the printer is made portable, its arrangement has to be simplified, so that this bears such a problem that it is impossible to obtain a memory capacity and operating performance sufficiently. However, if the information communication service can be used in a vehicle which is a transportation, the foregoing problem can be solved.

However, there were few kinds of communication service used in the vehicle conventionally. For example, there existed only such information communication service as a telephone or a facsimile which are installed in an airplane or a train. While, recently, electric devices, having an information communication function, such as a cellular phone have been spreading. Thus, if passengers can effectively use information communication service used outside the vehicle also inside the vehicle by using the electric devices having information communication function, this is very useful.

Recently, in a field of the inside-vehicle communication, the following inside-vehicle communication system has been proposed. The inside-vehicle communication system can be used continuously without interrupting the communication even in a case where the vehicle moves at high speed. For example, such inside-vehicle communication system is described by Japanese Unexamined Patent Publication No. 164640/1998 (Tokukaihei 10-164640) (publication date: Jun. 19, 1998), and Japanese Unexamined Patent Publication No. 28636/2001 (Tokukai 2001-28636) (publication date: Jan. 30, 2001). Further, Japanese Unexamined Patent Publication No. 190595/1998 (Tokukaihei 10-190595) (publication date: Jul. 21, 1998) and Japanese Unexamined Patent Publication No. 294702/1998 (Tokukaihei 10-294702)(publication date: Nov. 4, 1998) disclose information communication service which can be shared by passengers in the vehicle by using the electric devices having the information communication function. For example, as the information communication service, a train guiding system makes radio telephone apparatuses of respective passengers display train guiding information in a train.

However, conventionally, the information communication network system, in which the information communication is performed in the vehicle, was not built sufficiently. Thus, there were many restrictions in a case where the information communication was performed in the vehicle, so that there existed a problem that an environment for performing the information communication was not arranged sufficiently, compared with the outside of the vehicle. Concretely, in order to perform the information communication service with respect to the electric device which is a information communication terminal, it is required to build the information communication network in the vehicle, and it is required to provide a base station, which transmits and receives information to and from the electric device, the information communication terminal, in the vehicle. However, if the base station can be accessed by the electric device unlimitedly, there is possibility that speed of communication becomes so slow that it is impossible to perform the information communication service smoothly. Further, it is also impossible to perform such service that specific information is given to a specific user (a part) of many users.

Further, in the train guiding system disclosed in Japanese Unexamined Patent Publication No. 190595/1998 (Tokukaihei 10-190595) (publication date: Jul. 21, 1998) and Japanese Unexamined Patent Publication No. 294702/1998 (Tokukaihei 10-294702)(publication date: Nov. 4, 1998), although the train guiding information common to all the passengers is displayed on the electric device, the system does not have a function for making the electric device display individual information required by each passenger. That is, in the train guiding system, information given to the passengers were restricted, so that information which satisfied the requirement of the users were not necessarily provided to the users. Thus, when the electric devices having a information communication function was used in the vehicle, it was impossible to provide sufficient service as the communication service due to the restriction of communication and the incomplete communication service.

### SUMMARY OF THE INVENTION

The first object of the present invention is to provide an inside-vehicle information communication method, an inside-vehicle information communication apparatus, an inside-vehicle information communication system, an inside-vehicle information communication program, and a recording medium storing the inside-vehicle information communication program, in which a information communication environment equivalent to a information communication environment outside a vehicle, that is, an information communication network system can be built, and smooth information communication service can be provided, when information communication is performed by using an electric device which is an information communication terminal, in the vehicle, a transportation.

The second object of the present invention is to provide a vehicle-provided communication network system in which only the user of the vehicle who satisfies a using condition can use the communication network.

The third object of the present invention is to provide a vehicle-provided communication network system in which it is possible to perform the information communication from the inside of the vehicle to an information communication network system outside the vehicle.

The fourth object of the present invention is to provide an information recording medium issuing apparatus which issues an information recording medium storing the using condition for the user of the vehicle to use the vehicle-provided communication network system.

The fifth object of the present invention is to provide an information recording medium issuing apparatus which issues an information recording medium which stores

(a) the using condition for the user of the vehicle to use the vehicle-provided communication network system and

(b) a using condition to use the vehicle, as one body.

In order to achieve the first object, the inside-vehicle information communication method according to the present invention includes the steps of: causing a server, provided in a vehicle, to output a request for vehicle using right information, possessed by a user, to an electric device possessed by the user, upon receipt of a request for connection outputted by the electric device; causing the server to receive the vehicle using right information, outputted from the electric device upon receipt of the request for the vehicle using right information; and causing the server to confirm whether the electric device has the using right or not, in accordance with the vehicle using right information, and to allow an electric device having the using right of the vehicle to be connected to the server.

The vehicle is a transportation for carrying the user to his/her destination, and this particularly means a carriage and a compartment etc. of the transportation. Note that, the transportation includes, for example, a railroad, a bus, a monorail, an aircraft, a vessel, and so on.

The vehicle using right information is information which indicates that the user possesses right to use the vehicle, and can be called also electric ticket information. The information is stored in a memory area of the electric device of the user. Note that, the vehicle using right information may include information concerning a transport section in which the user can use the transportation, a using time slot, and a seat number etc.

The electric device of the user is an information communication terminal having a communication function, and is possessed by the user or lent to the user. Concretely, the electric device includes portable electric devices such as a cellular phone, a PHS, a PDA terminal, and an IC memory card.

According to the foregoing step, the server requests the electric device to output the inside-vehicle using right information in response to a request for connection outputted from the electric device of the user. In response to this, the inside-vehicle using right information is outputted from the electric device so as to be inputted to the server. Further, the server judges whether the user has the using right of the vehicle or not in accordance with the inputted vehicle using right information, and allows an electric device having the using right to be connected to the server. Thus, the server is connected only to the electric device having the using right in the vehicle, so that it is possible to solve such problem that communication is restricted since the line is busy.

In other wards, since only the electric device having the using right is connected to the server, it is possible to restrict users of the server, so that too much connection beyond the capacity is not performed. Thus, even in the vehicle, as long as the user has the electric device and the vehicle using right information, it is possible to receive smooth information communication service by performing a simple procedure. Further, the electric device having the using right can receive information different from information given to an electric device having no using right.

In order to achieve the first object, the inside-vehicle information communication apparatus according to the present invention which is provided in a vehicle so as to transmit and receive information to and from an electric device possessed by a user of the vehicle, includes: communication means for transmitting and receiving the information to and from the electric device; and a managing section (a) for outputting a request for vehicle using right information, possessed by the user, to the electric device possessed by the user, upon receipt of a request for connection outputted from the electric device, (b) for receiving the vehicle using right information via the communication means, (c) for confirming whether the user has the using right or not in accordance with the vehicle using right information, and (d) for allowing an electric device having the using right to be connected to the inside-vehicle information communication apparatus.

According to the foregoing arrangement, the managing section requests the electric device to output the vehicle using right information in response to the request for connection outputted from the electric device of the user. In response to this, the managing section receives the vehicle using right information via the communication means from the electric device, and confirms whether the user has the using right of the vehicle or not in accordance with the vehicle using right information. Thus, the managing section allows the electric device having the using right of the vehicle to be connected to the apparatus.

Thus, the inside-vehicle information communication apparatus is connected only to the electric device having the using right of the vehicle, so that it is possible to solve such a problem that communication is restricted since the line is busy.

In other wards, only the user having the using right can use the inside-vehicle information communication apparatus, so that too much connection beyond the capacity is not performed. Thus, even in the vehicle, as long as the user has the electric device and the vehicle using right information, it is possible to receive smooth information communication service by performing a simple procedure.

In order to achieve the first object, the inside-vehicle information communication system according to the present invention includes: the inside-vehicle information communication apparatus; and an electric device having (a) a radio section for transmitting and receiving information to and from the communication means of the inside-vehicle information communication apparatus, (b) a memory section which stores vehicle using right information and private information, (c) a controlling section which controls the radio section and the memory section.

According to the foregoing arrangement, the controlling section transmits the private information of the electric device, which is stored in the memory section, to the communication means of the inside-vehicle information communication apparatus. Thus, the managing section of the inside-vehicle information communication apparatus can specify the electric device. As a result, the inside-vehicle information communication apparatus can connect to the specific electric device, so that it is possible to build a information communication network in the vehicle. That is, since the information communication network is built between the server and respective users, the server can provide different information to the respective users. Thus, it is possible to provide the inside-vehicle information communication system which can perform various information providing service according to the request of each user.

Further, since only the user having the vehicle using right can use the server, it is possible to restrict users of the server. Thus, too much connection beyond the capacity is not performed, so that there is no problem such as a restriction of communication.

In order to achieve the first object, the inside-vehicle information communication system according to the present invention, includes: the vehicle for carrying the user; and the inside-vehicle information communication apparatus.

According to the foregoing arrangement, since the information communication network can be built even in the vehicle, it is possible to provide the user of the vehicle with the same service as information communication service performed outside the vehicle.

In order to achieve the first object, the inside-vehicle information communication program according to the present invention makes the server, provided in the vehicle, execute the respective steps of the inside-vehicle information communication method.

The program, for example, is loaded in the server, so that it is possible to apply the inside-vehicle information communication method to the inside-vehicle information communication apparatus or the inside-vehicle information communication system.

In order to achieve the first object, a medium storing the inside-vehicle information communication program according to the present invention makes the server, provided in the vehicle, execute the respective steps of the inside-vehicle information communication method.

The program stored in the recording medium, for example, is loaded in the server, so that it is possible to apply the inside-vehicle information communication method to the inside-vehicle information communication apparatus or the inside-vehicle information communication system.

In order to achieve the second object, the vehicle-provided communication network system according to the present invention, which performs information communication between the server, provided in the vehicle, and the information communication terminal, wherein: the information communication terminal which has (a) reading means for reading a using condition to use the system from a first information recording medium in which the using condition is recorded, and (b) transmitting means for transmitting the using condition, read by the reading means, to the server; and the server which has (a) memory means for storing the using condition to use the system, (b) a first checking means for checking the using condition, transmitted from the transmitting means, with the using condition, stored in the memory means, and (c) communication controlling means which enables information communication, performed between the server and the information communication terminal, only in a case where the first checking means judges that the both using conditions are identical to each other.

According to the foregoing arrangement, as long as the using condition stored in the first information recording medium is identical to the setted using condition, it is possible to perform information communication between the server and the information communication terminal in the vehicle-provided communication network system.

In order to achieve the third object, the vehicle-provided communication network system includes a server, provided in a vehicle, and an information communication terminal, which performs information communication between the server and the information communication terminal, wherein: the server which has (a) external communication means for performing the information communication with a information communication apparatus outside the vehicle, and (b) memory means for saving identification information of a portable communication terminal connected to the information communication terminal; and means for relaying communication performed between the information communication apparatus and the portable communication terminal, or receiving information transmitted from the information communication apparatus, instead of the portable communication terminal, in a case where the external communication means receives the information transmitted from the information communication apparatus to the portable communication terminal, the information being the identification information stored in the memory means.

According to the foregoing arrangement, in a case where the using condition stored in the first information recording medium is identical to the setted using condition, the server relays information communication performed between the information communication apparatus outside the vehicle and the portable communication terminal.

In order to achieve the fourth object, the information recording medium issuing apparatus according to the present invention which issues a first information recording medium storing a using condition to use a vehicle-provided communication network system in which information communication is performed between a server and a information communication terminal, and sets a first using condition to use the vehicle-provided communication network system and a second using condition to use the vehicle in advance, includes: a third reading means for reading a third using condition from a second information recording medium in which the third using condition to use the vehicle is stored; a second reading means for reading the second using condition that has been set; a second checking means for checking the second using condition, read by the second reading means, with the third using condition, read by the third reading means; a first reading means for reading the first using condition that has been set; and first recording means for recording the first using condition in the first information recording medium, wherein said first recording means records the first using condition in the first information recording medium, when the second checking means judges that the second using condition is identical to the third using condition.

According to the foregoing arrangement, the information recording medium issuing apparatus can issue the first information recording medium in which the using condition to use the vehicle-provided communication network system is stored, when the using condition recorded in the second information recording medium is identical to the setted using condition.

In order to achieve the fifth object, the information recording medium issuing apparatus according to the present invention which issues a third information recording medium recording a using condition to use a vehicle-provided communication network system in which information communication is performed between a server and a information communication terminal, and a using condition to use a vehicle, and sets a first using condition to use the vehicle-provided communication network system and a second using condition to use the vehicle in advance includes: outputting means for outputting a third using condition to use the vehicle; a second reading means for reading the second using condition that has been set; a second checking means for checking the second using condition read by the second reading means with the third using condition outputted by the outputting means; a first reading means for reading the first using condition that has been set; and a second recording means for recording the first using condition, and the second using condition, in a third information recording medium, wherein the second recording means records the first using condition and the second using condition in the third information recording medium, when the second checking means judges that the second using condition is identical to the third using condition.

According to the foregoing arrangement, when the outputted using condition is identical to the setted using condition, the information recording medium issuing apparatus can provide the third information recording medium which stores (a) the using condition to use the vehicle and (b) the using condition to use the vehicle-provided communication network system.

For a fuller understanding of the nature and advantages of the invention, reference should be made to the ensuing detailed description taken in conjunction with the accompanying drawings.

### BRIEF DESCRIPTION OF THE DRAWINGS

FIG. 1(a) is a block diagram showing electric devices used in an inside-vehicle information communication system of one embodiment of the present invention, and

FIG. 1(b) is a block diagram showing a vehicle common server used in the inside-vehicle information communication system.

FIG. 2 is an explanatory drawing showing an example of layouts of apparatuses, used in the inside-vehicle information communication system, which are provided in a train (vehicle).

FIG. 3 (a) is an explanatory drawing showing a ticket gate through which a user can pass in accordance with recognition of an electric ticket information, and

FIG. 3(b) is an explanatory drawing showing electric devices having the electric ticket information, and

FIG. 3(c) is an explanatory drawing showing another example of the electric devices.

FIG. 4 is a timing chart showing a procedure in which the electric devices and the vehicle common server, which are shown in FIG. 1(a), are connected to each other.

FIG. 5 is an explanatory table showing information which was saved in a memory of the vehicle common server shown in FIG. 1(b), and is managed by a managing section.

FIG. 6 is an explanatory drawing showing a using range (using time, using transport section) of respective users who sit on three predetermined seats in the train shown in FIG. 2.

FIG. 7 is a flow chart showing what service is provided, and how the service is provided in the inside-vehicle information communication system.

FIG. 8 is an explanatory drawing showing an example of a layout of apparatuses used for the vehicle-provided communication network system in the vehicle, according to one embodiment of the present invention.

FIG. 9 is an explanatory drawing showing an example of an arrangement of a vehicle user terminal provided on a front side of a seat in the vehicle shown in FIG. 8.

FIG. 10 is an explanatory drawing showing an arrangement of a ticket reading section connected to the vehicle user terminal, shown in FIG. 9, by an electric wire.

FIG. 11 is a block diagram showing an arrangement of the vehicle user terminal used for the vehicle-provided communication network system and the vehicle common server.

FIG. 12 is a flow chart showing how the vehicle-provided communication network system is used.

FIG. 13 is a block diagram showing an arrangement of apparatuses used for the vehicle-provided communication network system.

FIG. 14 is a block diagram showing an example of an arrangement of a vehicle net ticket issuing terminal.

FIG. 15 is a block diagram showing another example of an arrangement of a vehicle net ticket issuing terminal.

FIG. 16 is a diagram showing an example of content of information stored by the vehicle common server which is used for the vehicle-provided communication network system.

FIG. 17 is a flow chart showing a processing step of identification information.

FIG. 18 is an explanatory diagram showing an example of registered information in a case where files used in the vehicle are registered in the vehicle common server prior to use of the vehicle common server.

FIG. 19 is a flow chart for describing how the vehicle common server operates when the user finishes using the vehicle common server.

FIG. 20 is a flow chart showing how the user who uses the vehicle common server sets a term of validity.

### DESCRIPTION OF THE EMBODIMENTS

[First Embodiment]

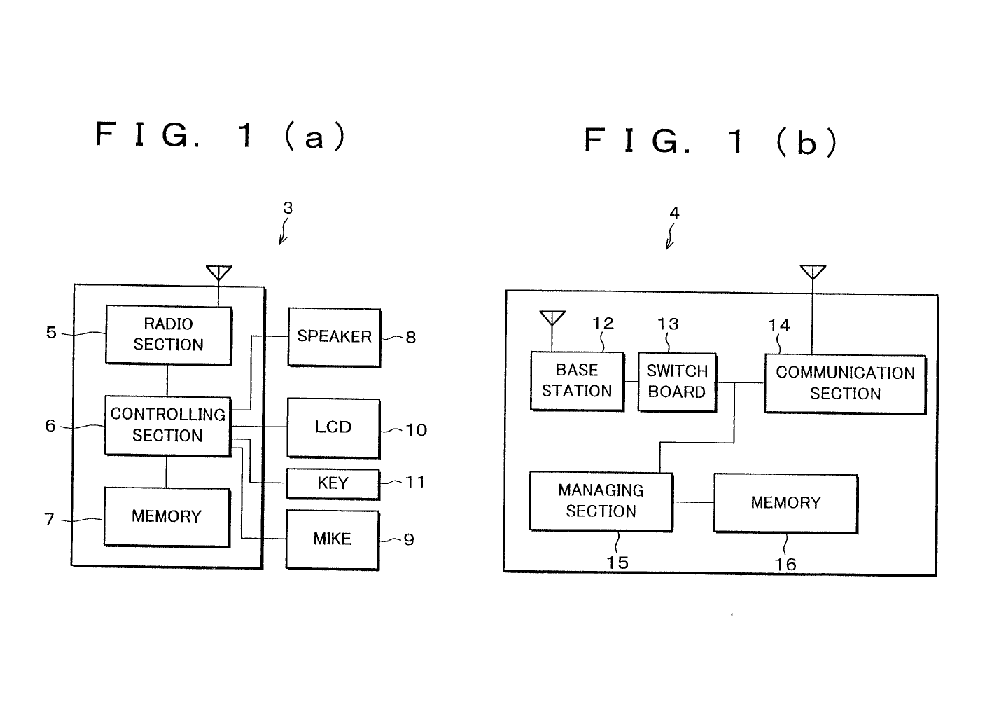

One embodiment of the present invention is described as follows based on FIG. 1 to FIG. 7.

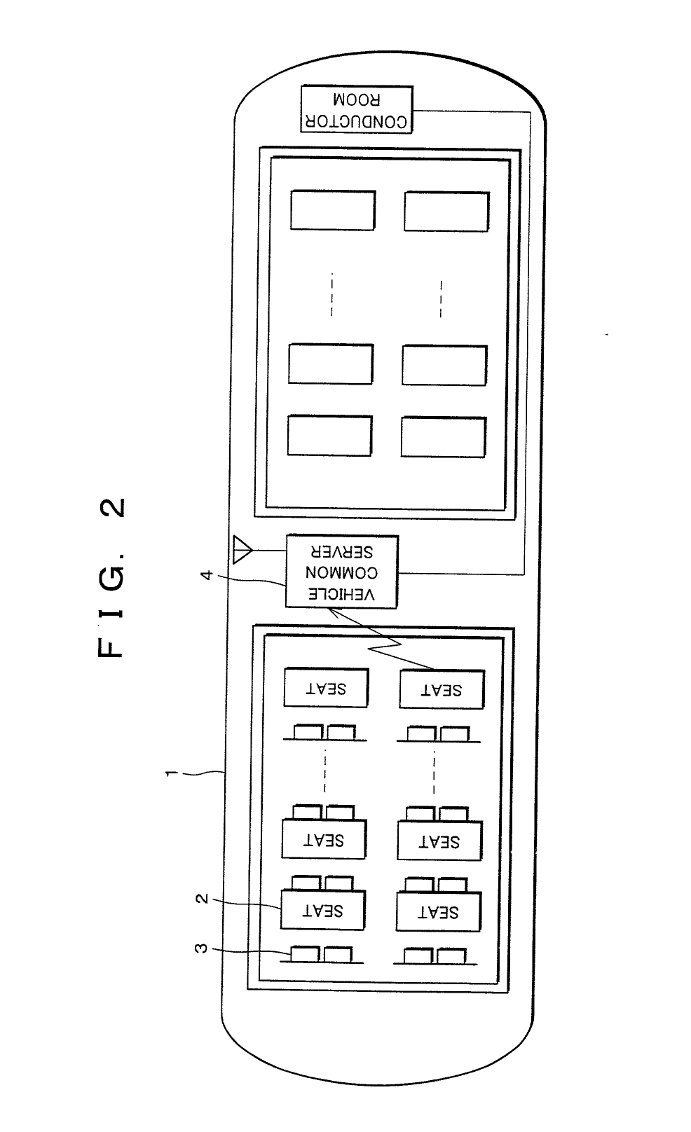

First, FIG. 2 shows an example of a layout of apparatuses, used in an inside-vehicle information communication network system of the present embodiment, which are provided on a train (vehicle). FIG. 2 is an explanatory drawing showing a layout of seats 2, electric devices 3 which function as a vehicle terminal, and a vehicle common server 4 (server, inside-vehicle information communication apparatus) in a train 1. Note that, although a number of components having the same function are shown in FIG. 2, a single component is described in order to simplify the description.

The train 1 is a carriage for carrying passengers in a railroad service etc. The seat 2 is a seat for the passenger (user) in the train 1. The electric device 3, which functions as the vehicle user terminal, is a information communication terminal which has a communication function, and it is possessed by the user. A concrete example of the electric device 3 includes portable electric devices such as a cellular phone, a PDA terminal, and an IC memory card. The vehicle common server 4 is a common server which can be shared so that respective users use the vehicle common server 4 in respective seats 2. Further, the vehicle common server 4 is connected to a display section (not shown) provided in a conductor room so that a conductor can find information required by the conductor, out of information inputted to and outputted from the vehicle common server 4. Note that, concrete arrangements of the electric device 3 and the inside-vehicle common server 4 are described as follows based on FIG. 1(a) and FIG. 1(b).

The electric device 3 includes a radio section 5; a controlling section 6; a memory (storing section) 7, a speaker (informing section) 8; a mike 9; an LCD (Liquid Crystal Display, displaying means) 10; and a key 11. The radio section 5 is a circuit which can transmit and receive an electric wave, and, for example, an RF circuit can be used as the radio section 5. The controlling section 6 is a computer to control the entire electric device 3, and to display on the LCD 10, and to process information inputted by means of the key 11. The memory 7 is a circuit to save various information inputted to the electric device 3, and, for example, a RAM (Random Access Memory) and a ROM (Read Only Memory) can be used as the memory 7. The speaker 8 is to give information to an owner of the electric device 3 through a sound. The mike 9 is to input a voice of the owner of the electric device 3. The LCD 10 is a screen to provide various information, inputted by the user by means of the key 11, and various information that the radio section 5 obtained, to the user. The key 11 is a switch by which various information is inputted by the user.

The vehicle common server 4 includes a base station (communication means) 12; a switchboard (switching means) 13; a communication section 14; a managing section (server) 15; and a memory 16. The base station 12 is a circuit to transmit and receive information to and from the electric device 3, the information communication terminal. The switching board 13 is a switch to switch a plurality of transmission paths of a communication line. In the present embodiment, the switching board 13 has a function as a switch to select a specific information communication terminal out of a plurality of information communication terminals connected to the vehicle common server 4. The communication section 14 is a circuit to perform the information communication with the outside of the vehicle. The managing section 15 is an calculation processing unit, a central portion of the vehicle common server 4, and controls the vehicle common server 4 so as to receive information from the base station 12 and the communication section 14, and performs a calculation process of the received information and saves the resultant, so as to output the resultant. For a concrete example, a CPU (Central Processing Unit) can be used as the managing section 15. The memory (saving section) 16 is a circuit to receive various information inputted to the vehicle common server 4 and information processed by the managing section 15, and to save the information. For example, a RAM and a ROM can be used as the memory 16. Note that, as long as a computer of the server can access the memory 16, the memory 16 is not restricted to an arrangement in which it is provided in the computer of the server. For example, as the memory 16, an external memory which is provided outside the computer, or a portable memory which is detachable, or a memory, provided on another computer which is connected to the computer via a network, may be used. Further, it does not matter whether an access path to the memory 16 is wired or not.

Note that, the radio section 5 of the electric device 3 possessed by the user is connected to the base station 12 of the vehicle common server 4 provided on the train 1 by, for example, a radio network communication such as a Bluetooth and a radio LAN (Local Area Network), or a cable network communication such as a LAN cable. Thus, it is possible to perform the information communication between the radio section 5 and the base station 12.

In this way, it is possible for plural electric devices 3 to access the vehicle common server 4 simultaneously. Further, it is possible for the plural electric devices 3 connected to the vehicle common server 4 to transmit and receive information via the base station 12, the switchboard 13, and the communication section 14 to and from the outside of the vehicle.

Further, the seats 2 are provided at predetermined intervals in the train 1, and each of the seats 2 has a stand (table) on which the electric device 3 is used by the user. Further, the user connects the electric device 3 to the stand so as to perform the information communication with the vehicle common server 4.

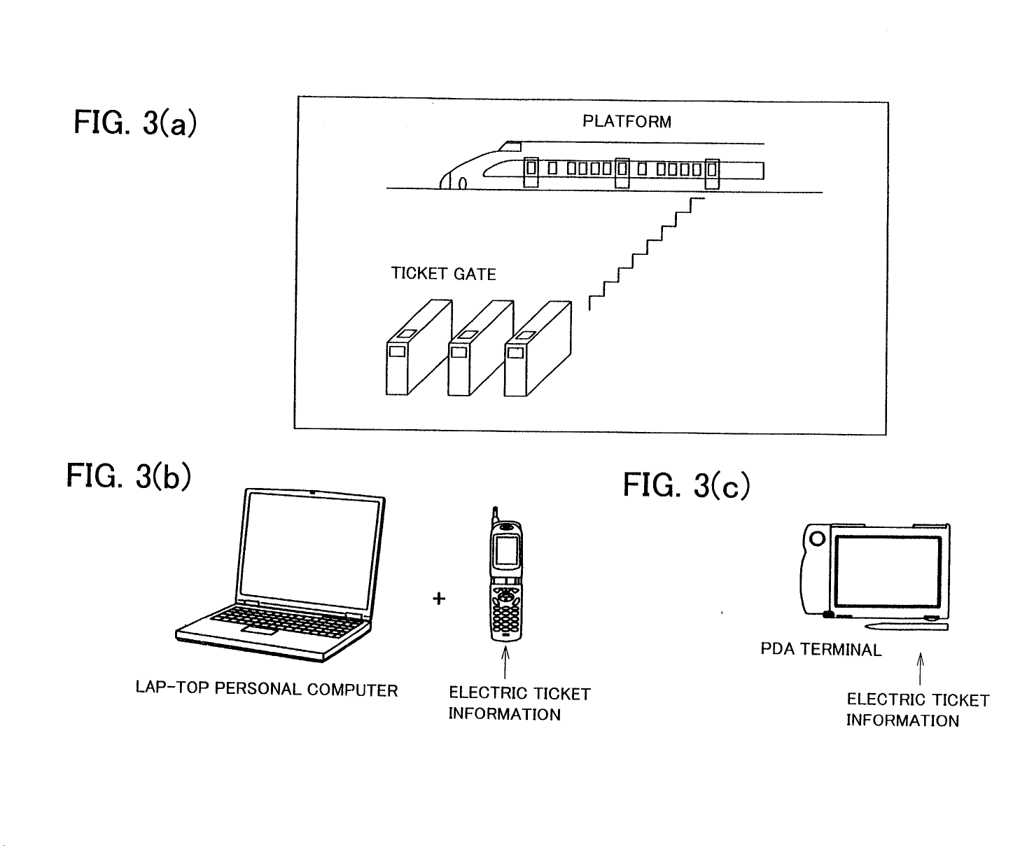

Next, the following is a description of an electric ticket information (vehicle using right information), stored in the electric device 3 possessed by the user, which is required in using a transportation. It is described based on FIG. 3(a) to FIG. 3(c).

The electric ticket information required in using a transportation is information showing that an owner of the electric ticket information possesses the right to use the train 1, and it is stored in an electric ticket information saving area of the memory 7 in the electric device 3 possessed by the user. Further, the electric device of the user passes through a predetermined area, so that a computer (not shown) confirms the electric ticket information of the user. When the computer judges that the user can use the transportation in accordance with the electric ticket information, the user is permitted to use the transportation, so that the user can pass through a ticket gate.

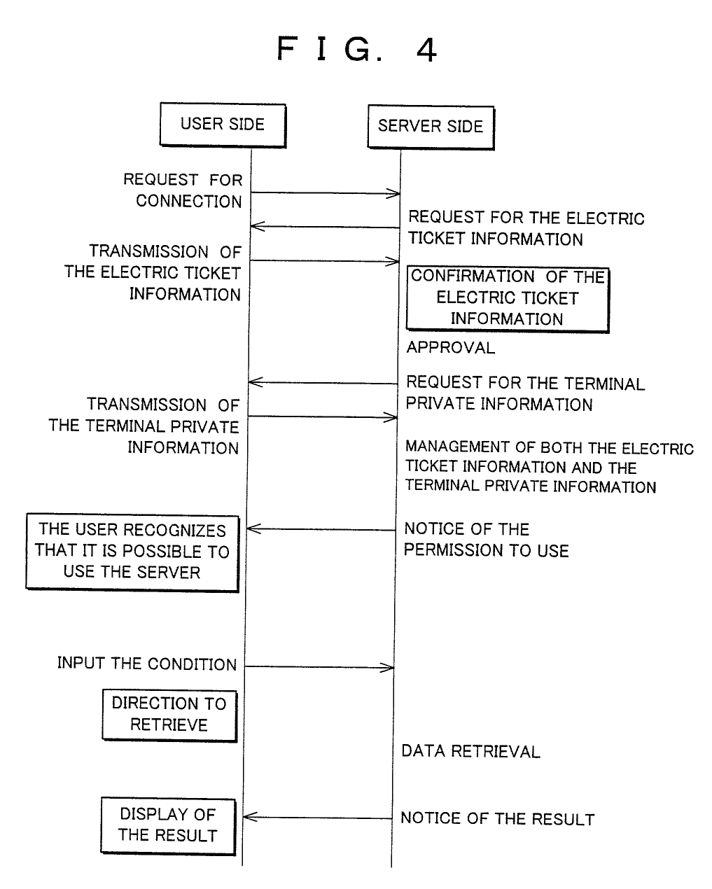

Further, how the user connects the electric device 3 to the vehicle common server 4 in the train 1 is described as follows based on FIG. 4.

First, the user sits on the seat (specified seat in a car) 2 which was specified in advance by the electric ticket information, which functions also as a passenger ticket. Further, the user side (controlling section 6) transmits “request for connection” to the server side (managing section 15) according to a predetermined operation of the user. Note that, the user inputs the “request for connection” by means of the key 11 so as to transmit the “request for connection” in the present embodiment, and it is also possible to output the request for connection to the server side by a panel operation of a connection request button etc. (not shown) provided on the seat 2.

Next, the server side receives the “request for connection” and transmits “request for electric ticket information”. Further, the user side transmits the electric ticket information, stored in the memory 7 of the electric device 3, to the server side. Thus, the server side confirms whether the electric ticket information transmitted from the user is appropriate or not (whether or not a car and a seat which are supposed to be used by the user correspond to a car and a seat which are actually used by the user).

Here, when the electric ticket information is appropriate, the server side transmits the electric ticket information to the memory 16, and the memory 16 saves the electric ticket information. Further, the server side allows the electric device 3 possessed by the user to be connected to the vehicle common server 4. Further, the server side transmits “request for terminal identification information (identification information)” to the user side so as to identify the electric device 3 possessed by the user. Note that, the terminal identification information is identification information by which the managing section 15 identifies the electric device 3.

Receiving the “request for terminal identification information (identification information)”, the user side performs “transmission of the terminal identification information”. The user transmits the terminal identification information which was stored in the memory 7, via the radio section 5 and the base station 12, to the server so as to perform the “transmission of the terminal identification information”. Thus, it is possible for the server side to identify the electric device 3 which functions as a terminal used by the user. Note that, the transmitted terminal identification information is stored in the memory 16.

Further, the server side manages the user's electric ticket information and terminal identification information saved in the memory 16, and transmits “permission to use”, which permits the user to use the vehicle common server 4, to the user side, and sets a network environment so that the electric device 3 possessed by the user can be connected to the vehicle common server 4.

Further, the user can recognize that it is possible to use the server, according to the “permission to use”. Thus, it is possible for the user to receive various information providing service.

For example, the user inputs a condition (for example, a destination) to obtain information required by the user (for example, sight seeing information concerning the destination) by operating the key 11 of the electric device 3. The inputted condition is transmitted via the radio section 5 and the base station 12 to the server side. Next, the server side retrieves information from the memory 16 in accordance with the transmitted condition, and specifies information required by the user. Further, the server side transmits a result of specifying information to the user side. Further, the result, that is, the information required by the user is displayed on the LCD 10 on the side of the user. Thus, it is possible for the user to obtain the information required by the user.

Note that, in the foregoing descriptions, the server side outputs the request for the electric ticket information to the user side in response to the request for connection outputted from the user side, and the user side transmits the electric ticket information to the server side upon receipt of the request. However, the arrangement is not restricted to the foregoing procedure, but the following procedure may be used. The user side may transmit the electric ticket information and perform the request for connection simultaneously, or may transmit the electric ticket information after performing the request for connection, without receiving the request for the electric ticket information outputted from the server side to the user side.

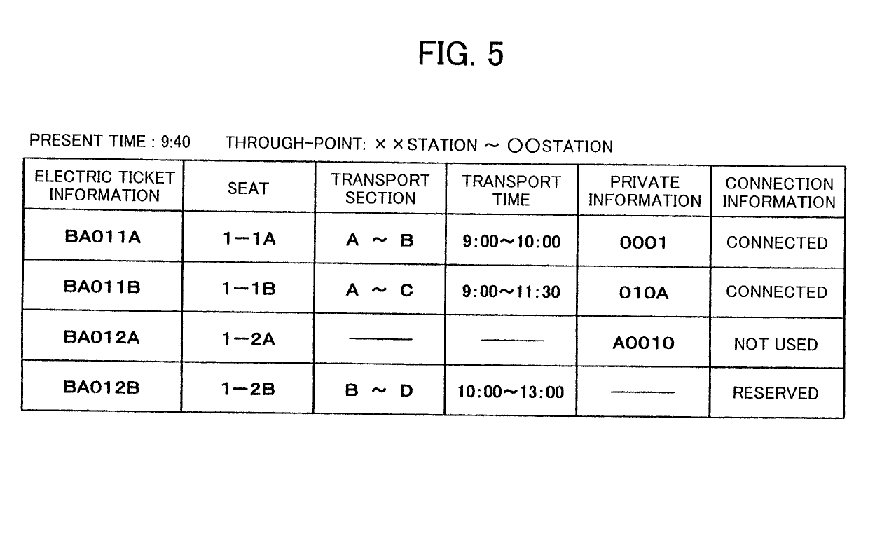

Next, the following is a description of information concerning the user and information concerning the transportation of the vehicle both of which are stored in the memory 16 and is managed by the managing section 15. The both information are described as follows based on FIG. 5. Note that, the information concerning the user is information which can be recognized by the managing section 15 in accordance with the inputted vehicle using right information. Further, the information concerning the transportation of the vehicle is information which shows a running schedule of the vehicle.

As shown FIG. 5, information (items) such as “electric ticket information”, “seat number”, “transport section”, “transport time slot”, “terminal identification information”, and “connection state” of the respective seats are saved in the memory 16. Further, FIG. 5 shows that the present time is 9:40, and the train 1 runs between × × station and ∘ ∘ station. Further, FIG. 5 shows that seats “1-1A” and “1-1B” are occupied by the users, and the electric devices 3 of the users who occupy the seats are connected to the vehicle common server 4. Further, it is shown that, although seats “1-2A” and “12B” are vacant, “1-2B” is scheduled to be used between sections B to D, that is, 10:00 to 13:00.

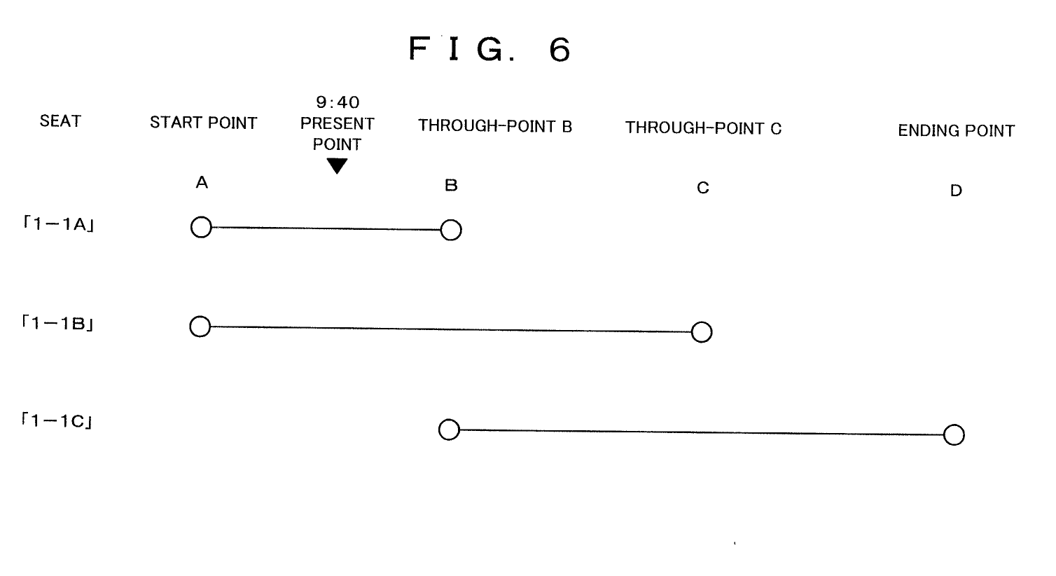

Next, how individual information required by each user is provided to the user is described as follows based on FIG. 6. Note that, the individual information required by each user is information according to each user's request and necessity. For example, the information includes time taken to get to a predetermined station, the distance to the station, transfer information, sight seeing information of the destination and a periphery of a halfway point, accommodation information, weather information, and so on.

FIG. 6 is an explanatory drawing showing information of a transport time slot managed by the managing section 15, and it is a graph which shows using ranges (using time, using section) of the respective users of the respective seats “1-1A”, “1-1B”, and “1-2B”. As shown in FIG. 6, the managing section 15 which manages the vehicle common server 4 also manages a point through which the train is running, and the present time.

First, the managing section 15 recognizes the information concerning the user in accordance with the inputted electric ticket information. Next, the managing section 15 specifies the individual information required by each user in accordance with the information concerning the user and the mobile information concerning the transportation of the vehicle which is stored in the memory 16. Further, the managing section 15 outputs the individual information, and transmits the individual information to the electric device 3 of the user. Further, the controlling section 6 informs (notifies) the user of the individual information by means of the LCD 10 or the speaker 8.

Further, when a period in which the electric device 3 can remain connected to the vehicle common server 4 comes near to an end, or the transport section (using section) comes near to an end (destination), the managing section 15 recognizes this state in accordance with the individual information. Further, the managing section 15 outputs information indicating that a period in which the electric device 3 can remain connected to the vehicle common server 4 comes near to an end, or the transport section comes near to an end, so as to transmit the information to the electric device 3 of the user. Further, the controlling section 6 informs (notifies) the user of the information by means of the LCD 10 or the speaker 8. Note that, the following service may be employed. The vehicle common server 4 informs the user of the information via a panel (informing means) provided on the seat by a message display etc. Note that, the informing means is a device for informing the user of the information. For example, the informing means includes a display such as the LCD and a speaker etc. which are provided on the respective seats.

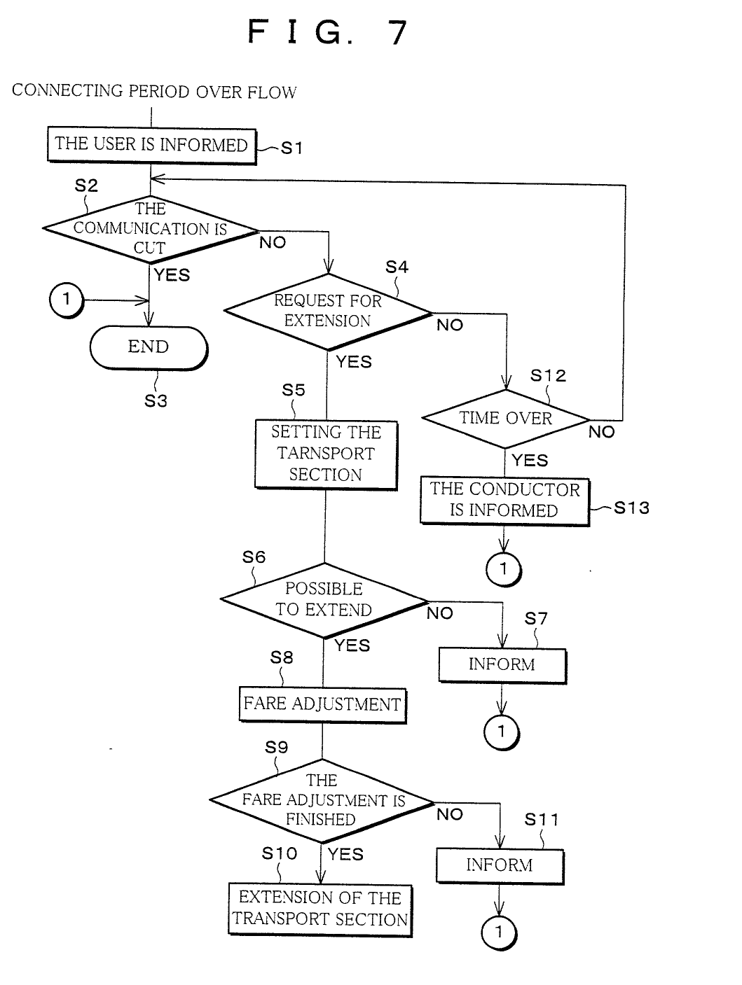

Further, content and a procedure of another service is described as follows based on a flow chart shown in FIG. 7.

As described above, when the train 1 comes near to a destination of the user, the managing section 15 which manages the vehicle common server 4 recognizes that the train 1 comes near to the destination based on the individual information, and informs the user that the train 1 comes near to the destination (S1). Thereafter, in a case where the connection of the electric device 3 and the vehicle common server 4 is cut off within a predetermined time (by the time when the train reaches the destination), the managing section 15 judges that the user is making ready to get off the train 1 (S2, YES), and finishes the connection between the electric device 3 and the vehicle common server 4 (S3).

While, in a case where the user does not cut off the connection (S2, NO), and the user wants to extend the using time of the vehicle common server 4, that is, the user wants to ride past the predetermined station (S4, YES), the user inputs a transport section, in which the user wants to ride past the predetermined station, to the electric device 3 by operating the key 11 (S5). Further, the inputted information is transmitted from the electric device 3 to the vehicle common server 4. Further, the managing section 15 confirms the section in which the user wants to ride past the predetermined station in accordance with the inputted information, and judges whether or not it is possible to use the seat in the transport section (S6). When it is impossible to extend the using time of the seat due to some circumstances including a circumstance that the seat is reserved in the transport section (S6, NO), the managing section 15 informs the user that it is impossible to extend the using time of the seat (S7), and the managing section 15 finishes the connection of the electric device 3 and the vehicle common server 4.

While, when it is possible to extend the using time of the seat (S6, YES), the managing section 15 informs the user, via the electric device 3, that it is possible to extend the using time of the seat, and the managing section 15 adjusts the extra fare (S8). The fare adjustment is performed via the electric device 3 of the user by an electric settlement. Further, when the managing section 15 finishes confirming the fare adjustment (S9, YES), information (information like a managing table shown in FIG. 5) managed in the vehicle common server 4 is renewed as an extension of a transport section (S10). Further, in a case where the fare adjustment is not performed by the managing section 15, for example, in a case where the user rejects payment of the extra fare (S9, NO), the managing section 15 informs the user, via the electric device 3, that the transport section in which the user can use the train 1 is not to be extended (S11), and the managing section 15 finishes the connection between the electric device 3 and the vehicle common server 4 (S3).

Further, in a case where the managing section 15 informs the user, via the electric device 3, that the train 1 comes near to the destination, and the user does not react (response) at all for a predetermined period (S12, YES), the managing section 15 displays this state on a display panel of a conductor room (S13). At the same time, the managing section 15 finishes the connection between the electric device 3 and the vehicle common server 4. Thus, a conductor directly asks the user whether or not the user requires extension of the transport section in which the user can use the train 1. Note that, in a case where the user responds within a predetermined period (S12, NO), a step goes back to S2.

Here, the fare adjustment means to ask the user to pay the extra fare. Further, the electric settlement, which is a way to perform a settlement via a network in an electric business transaction etc., includes a credit card settlement, a bank account settlement, electric money, an electric check, and so on.

Here, how the electric settlement is performed is described as follows. When the user requests for the extension of the traveling section, the user inputs a destination by operating the key 11. Further, the controlling section 6 transmits a card number of a credit card etc. and the inputted destination, which were stored in the memory 7, to the vehicle common server 4. Next, the managing section 15 calculates the fare in accordance with the electric ticket information and the inputted destination. Further, the managing section 15 transmits the card number and the amount of the calculated fare, via the communication section 14, to a credit company etc., and requests for the approval. When the approval is obtained, the fare is paid. Note that, it is possible to ask the user for the extension fare not only when the user is informed that the user comes near to his/her destination, but also whenever the vehicle common server 4 is connected to the electric device 3.

Further, when the electric device is an IC memory card, it is possible to perform the electric settlement by using the electric device as the electric money.

Note that, the fare adjustment may be performed as follows. The conductor comes to the seat 2 so that cash is directly paid from the user to the conductor, other than the electric settlement etc.

Further, in a case where the transportation delays, the managing section 15 rectifies information of transport time slots etc. managed by the vehicle common server 4. Further, the managing section 15 rectifies (reflects) various processes required in performing the foregoing services. That is, the managing section 15 adjusts timing when the respective processes required in the service begins.

Besides, the vehicle common server 4 informs the user, via the LCD which is a display section of the electric device 3 of the user or via a panel (display section: display) provided on the seat (not shown), of a state of the train service (transportation itself), sight seeing information, transfer information, and so on, and retrieves and provides information the user requires, according to the request of the user. Thus, it is possible to provide information while moving.

Note that, although the present embodiment shows the case where the inside-vehicle information communication network system is used in the train 1, it is possible to apply the system to transportation other than a train. For example, it is possible to apply the system to a bus, a monorail, an aircraft, and a vessel.

Further, time rectification is performed with respect to deviation which occurs in a transport time, and the rectification is used to perform various processes, so that it is useful for the user.

Further, it is needless to say that, a recording medium, which stores a program code of software for realizing foregoing functions of the embodiment, is provided to a system or an apparatus so that a computer of the system or the apparatus, or a CPU or an MPU (Microprocessor Unit) executes the program code stored in the recording medium. Thus, the object of the present invention is achieved. In this case, the program code itself read from the recording medium realizes the foregoing functions of the embodiment, so that the recording medium which stores the program code makes up the present invention. As the recording medium for providing the program code, for example, a floppy disc, a hard disc, an optical disc, a photo-electro-magnetic disc, a CD-ROM (Compact Disc-Read Only Memory), a CD-R (Compact Disc-Recordable), a magnetic tape, a nonvolatile memory card, and a ROM can be used.

Further, it is needless to say that the foregoing functions of the embodiment is realized not only by executing the program code read by the computer, but also by an actual process which is performed partially or wholly, based on a direction of the program code, by an OS (Operating System) which operates on the computer.

Further, it is needless to say that after the program code read from the recording medium is written in a memory which is provided on a function-expansion board inserted into a computer or a function-expansion unit connected to the computer, a CPU etc., which are provided on the function-expansion board or the function-expansion unit, perform an actual process partially or wholly in accordance with the program code, and the process realizes the foregoing functions of the embodiment.

According to the present invention, it is possible for the user of the vehicle to easily use the server provided in the vehicle, as long as the user possesses the electric ticket information and the electric device. Thus, it is possible to perform information communication (from business use to private use) by using the inside-vehicle communication network system until the vehicle reaches the destination.

Further, it is possible to perform processes such as information of arrival and fare adjustment before the user arrives at his/her destination. Thus, this is useful for the user.

Lastly, the foregoing embodiment does not restrict scope of the present invention, and can be varied in many ways within the scope of the present invention.

[Second Embodiment]

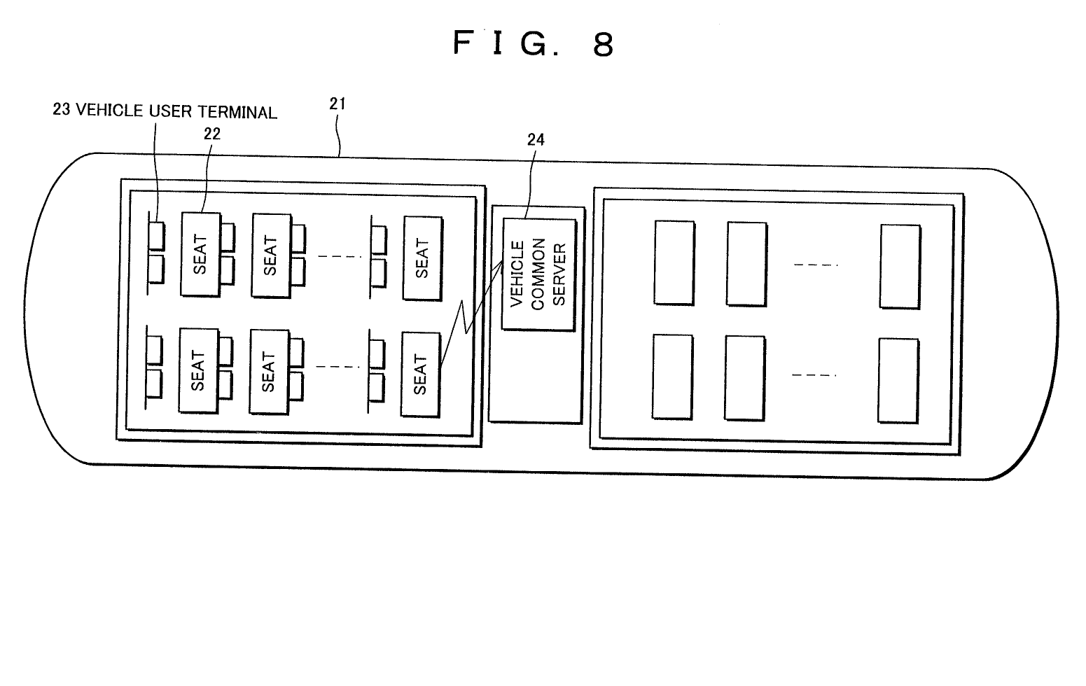

One embodiment of the vehicle-provided communication network system of the present invention is described as follows, based on FIG. 8 to FIG. 12.

FIG. 8 shows an example of a layout of apparatuses, used in the vehicle-provided communication network system according to the present embodiment, which are provided in a vehicle 21 such as an aircraft and carriages. However, FIG. 8 is an explanatory drawing, a horizontally cross sectional view of the vehicle 21, shows a layout of a seat 22, a vehicle user terminal (information communication terminal) 23, and a vehicle common server (server) 24, in the vehicle 21. Note that, although a number of components having the same function are shown in FIG. 8, a single component is described in order to simplify the description.

The vehicle user terminal 23 is an information communication terminal which is used when a user of the vehicle 21 uses the vehicle-provided communication network system. The vehicle common server 24 is a server which can be shared by users of the inside-vehicle communication network system (hereinbelow referred to as user) from respective seats 22.

In the vehicle 21, the seats 22 are provided at an appropriate intervals in the vehicle 21, and each vehicle user terminal 23 is provided on a front side of each seat 22. Further, the user uses the vehicle user terminal 23, so that it is possible to perform information communication by means of the vehicle common server 24. Further, the vehicle common server 24 is connected to the vehicle user terminals 23 provided on front sides of other seats 22 in the vehicle 21, so that the users can use the vehicle common server 24 from the respective seats 22.

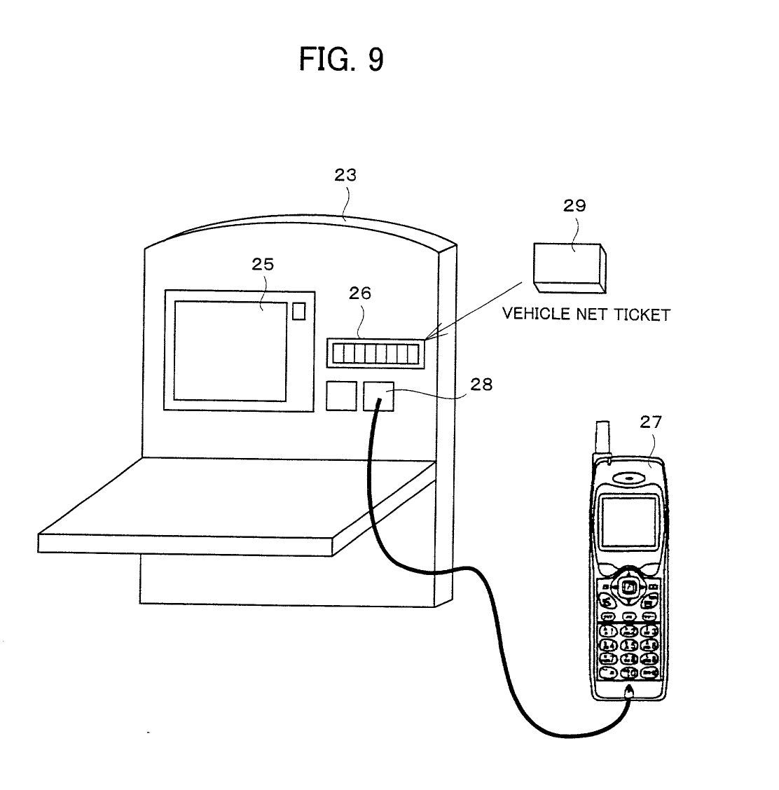

FIG. 9 is an explanatory drawing showing an example of how the vehicle user terminal 23, provided on the front side of the seat 22, is arranged. The vehicle user terminal 23 includes, as main components, a display device 25, a ticket reading section (reading means) 26, and a connector 28 for connecting the vehicle user terminal 23 to a portable terminal (portable communication terminal) 27.

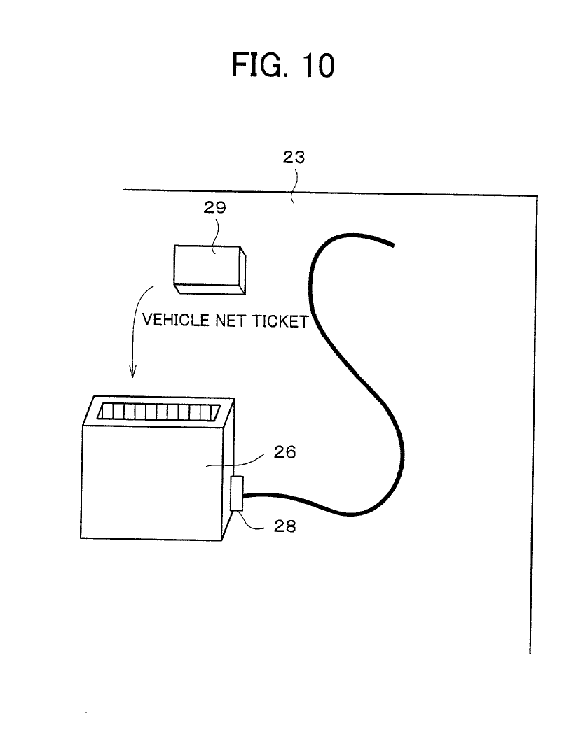

The ticket reading section 26 includes an entry into which an vehicle net ticket (first information recording medium) 29 is inserted, and reads information stored in the vehicle net ticket 29 inserted into the ticket reading section 26. Further, the ticket reading section 26 may be arranged so that the ticket reading section 26 is connected via a wire to the vehicle user terminal 23 instead of mounting the ticket reading section 26 on the vehicle user terminal 23 as one body. Note that, an arrangement of the ticket reading section 26 connected via the wire to the vehicle user terminal 23 is shown in FIG. 10.

The portable terminal 27 is connected via the connector 28 to the vehicle user terminal 23, so that information communication, in which the vehicle common server 24 is used, can be performed through the portable terminal 27 and the vehicle user terminal 23. While, in a case where the user does not use the vehicle common server 24, the user uses the portable terminal 27 so as to perform information communication with other potable terminals. Note that, although the portable terminal 27 is connected to the connector 28 by a wire in FIG. 9, they may be connected to each other by radio.

Next, an operation of the vehicle user terminal 23 in use is described as follows.

When the vehicle net ticket 29 is inserted into the entry of the ticket reading section 26, the ticket reading section 26 reads server using right information stored in the vehicle net ticket 29, and transmits the server using right information to the vehicle common server 24. Next, the vehicle common server 24 checks the received server using right information with information stored in the vehicle common server 24. When the server using right information is identical to the information stored in the vehicle common server 24, it is possible to perform information communication between the vehicle common server 24 and the vehicle user terminal 23. Note that, in a case where the user uses the portable terminal 27, information communication begins between the vehicle common server 24 and the portable terminal 27.

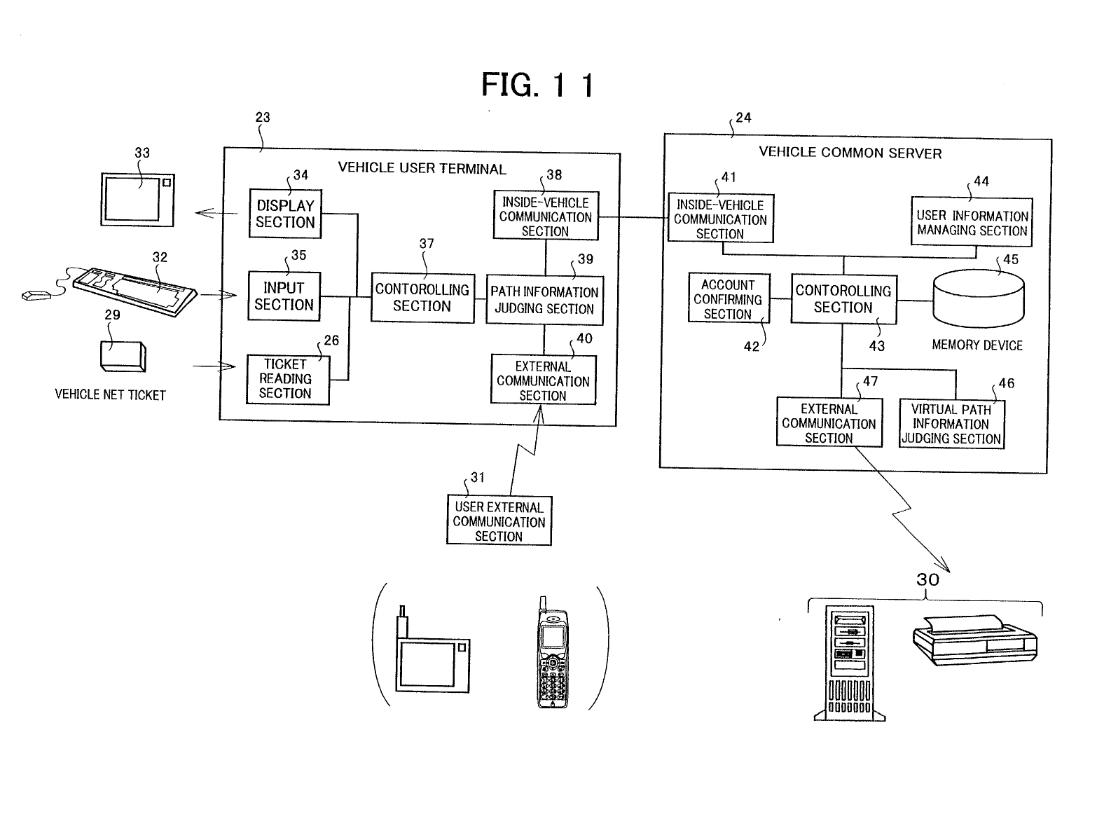

FIG. 11 is a block diagram showing an example of how the vehicle-provided communication network system of the present invention is arranged. In FIG. 11, blocks show main components of the vehicle-provided communication network system.

In the vehicle-provided communication network system, information communication is performed between the vehicle user terminal 23 and the vehicle common server 24. When the information communication is performed, as other components, for example, a vehicle net ticket 29, a peripheral device 30, a user external communication section 31, a keyboard section 32, and a display device 33 are used.

The vehicle user terminal 23 includes: a display section 34; an input section 35; a ticket reading section 36; a controlling section 37; a vehicle communication section (transmitting means) 38; a path information judging section (switching means) 39; and an external communication section 40. The vehicle user terminal 23 is a terminal used by the user.

The display section 34 controls a display operation of the display device 33. The input section 35 receives information inputted through the keyboard 32 operated by the user. The ticket reading section 36 reads a using condition from the vehicle net ticket 29 which stores the using condition to use the vehicle-provided communication network system. The controlling section 37 controls information processes performed in respective sections of the vehicle user terminal 23. The vehicle communication section 38 transmits and receives information to and from the vehicle common server 24. The path information judging section 39 judges a path of information which is to be transmitted, and a path of information which was received. The external communication section 40 transmits and receives information to and from an information communication apparatus outside the vehicle 21, that is, to and from the user outside communication section 31.

The vehicle common server 24 includes a vehicle communication section 41, an account confirming section (first checking means) 42, a controlling section (communication controlling means, means for relaying information or receiving information instead of the user terminal, means for forwarding information to a information communication apparatus outside the vehicle, specifying information registration means, deleting means, start time setting means, and environment setting means) 43, a user information managing section 44, a storing device (storing means) 45, a virtual path information judging section 46, and an external communication section (external communication means) 47, and provides a network environment which is shared by the users in the vehicle 21.

The vehicle communication section 41 transmits and receives information to and from the vehicle user terminal 23. The account confirming section 42 confirms whether or not a using condition stored in the vehicle net ticket 29 is identical to a using condition which was setted in advance. The controlling section 43 controls information processes performed in the respective sections of the vehicle common server 24.

The user information managing section 44 stores information concerning a using environment of the vehicle-provided communication network system. The storing device 45 stores a using condition for the user to use the vehicle-provided communication network system, that is, stores a server using right information. The virtual path information judging section 46 judges a virtual path information which is set as a preparation for a case where the outside communicates with the user while the vehicle common server 24 is being used. The external communication section 47 transmits and receives information to and from a terminal or the peripheral device 30, which are connected to a communication network outside the vehicle, and the vehicle common server 24.

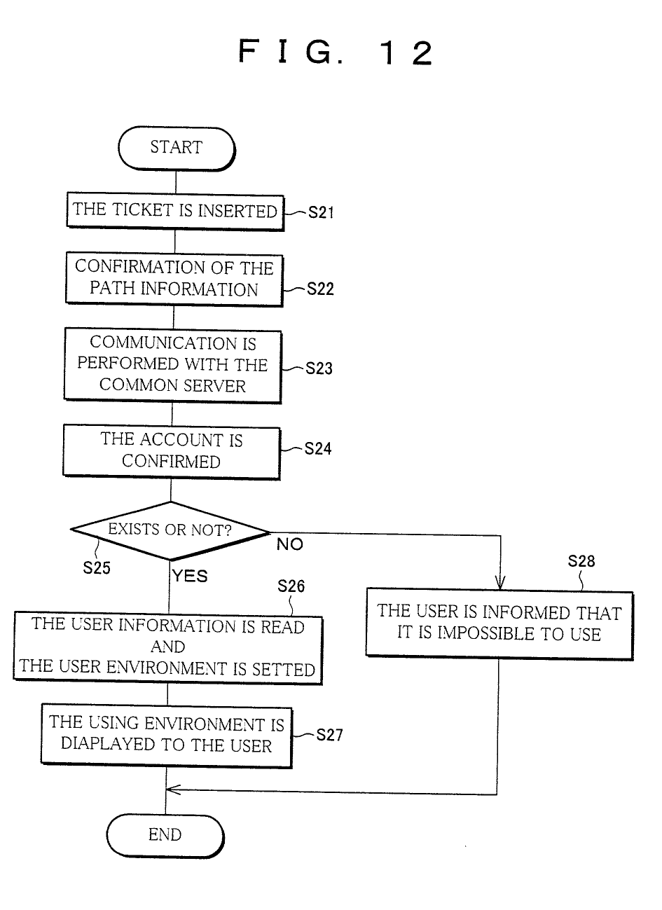

Next, an operation of the vehicle-provided communication network system of the present invention is described with reference to FIG. 12. FIG. 12 is a flow chart showing the operation of the vehicle-provided communication network system.

When the user inserts the vehicle net ticket 29, which stores a using condition to use the vehicle-provided communication network system, into the ticket reading section 26 of the vehicle user terminal 23, the using condition is read by the ticket reading section 26 (S21). The path information judging section 39 confirms path information concerning a information processing path, in accordance with the using condition which was read by the ticket reading section 26 (S22). The vehicle communication section 38 communicates with the vehicle communication section 41 of the vehicle common server 24 in accordance with the path information (S23). That is, the using condition read by the ticket reading section 26 is transmitted from the ticket reading section 26 via the vehicle communication section 38 to the vehicle communication section 41.

The controlling section 43 receives the using condition, which was transmitted from the ticket reading section 26 to the vehicle communication section 41, from the vehicle communication section 41. Further, the controlling section 43 makes the account confirming section 42 confirm the using condition (account information) to use the vehicle-provided communication network system. The account confirming section 42 retrieves content of the storing device 45 via the controlling section 43, and confirms whether there exists account information corresponding to the using condition or not.

As a result, when the account information corresponding to the using condition exists (when a judgement YES is given in S25), the controlling section 43 reads information concerning a using environment from the user information managing section 44, and sets the using environment of the user (S26).

Further, the controlling section 43 transmits the read information, which concerns the using environment, via the vehicle communication sections 38 and 41, and the controlling section 37, to the display section 34. While, the display section 34 makes the display device 33 display the using environment (S27), and finishes an operation to begin using the vehicle-provided communication network system. Thus, the user can perform information communication.

On the other hand, when the account information corresponding to the using condition does not exist (when a judgement NO is given in S25), the display section 34 makes the display device 33 display phrases showing that the communication network system cannot be used (S28), and finishes the operation. That is, in this case, the user cannot perform the information communication.

Lastly, the foregoing embodiment does not restrict scope of the present invention, and can be varied in many ways within the scope of the present invention.

[Third Embodiment]

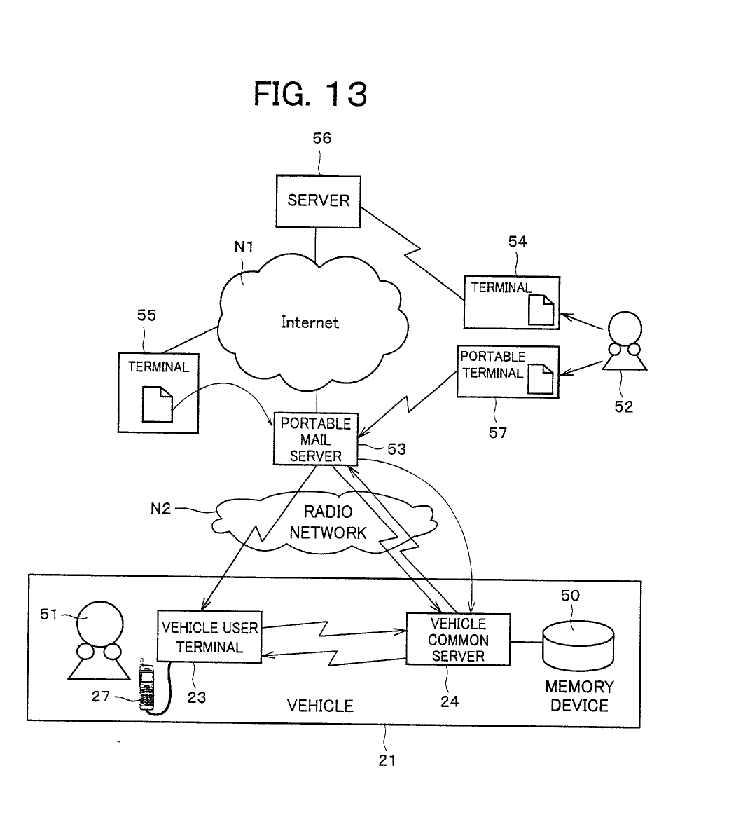

Another embodiment of the vehicle-provided communication network system of the present invention and one embodiment of a information recording medium issuing apparatus of the present invention are described as follows based on FIG. 13 to FIG. 20. Note that, members having the same functions as members of the second embodiment are given the same numerals, and descriptions thereof are omitted.

FIG. 13 is a block diagram showing an example of how the vehicle-provided communication network system of the present invention is arranged. In FIG. 13, blocks show main components of the vehicle-provided communication network system.

The vehicle 21 includes a vehicle user terminal 23, a portable terminal 27, a vehicle common server (server) 24, and a storing device (storing means) 50 therein. A user 51 of the inside-vehicle information communication system (hereinbelow referred to as “user 51”) can perform information communication by using these devices.

When received information cannot be forwarded to a sending end, the vehicle common server 24 makes the saving device 50 save the received information. A terminal which can use this function is registered in the vehicle common server 24, and the portable terminal 27 is registered as a terminal which can use the function. Thus, when the received information, which is to be forwarded to the portable terminal 27, cannot be forwarded to the portable terminal 27, the vehicle common server 24 makes the saving device 50 save the received information. In this case, the vehicle common server 24 makes the vehicle user terminal 23 display phrases indicating that the vehicle common server 24 made the saving device 50 save the received information, which is to be forwarded to the portable terminal 27. Note that, for a concrete example, there is a case where the received information cannot be forwarded to the portable terminal 27 because the user 51 is transmitting and receiving information to and from the outside by using the portable terminal 27. That is, the saving device 50 can save the account information described in the second embodiment, and it is possible for the saving device 50 to save the information received by the vehicle common server 24.

Besides, as devices by which the user 51 performs information communication with a user 52 of the Internet N1 outside the vehicle 21 (hereinbelow referred to as “user 52”), there are a portable mail server 53, terminals 54 and 55, a server 56, and a portable terminal 57 outside the vehicle 21.

The portable mail server 53 is used when information communication is performed by using the portable terminal 57. The terminal 54 is a terminal by which the user 52 of a communication network N1, provided outside the inside-vehicle 21, performs information communication. The portable terminal 57 is used by the user 52.

Next, an operation of the vehicle-provided communication network system arranged in the foregoing way is described as follows.

When the user 52 outside the vehicle transmits a mail, by using the terminal 54 or the portable terminal 57, to the portable terminal 27 of the user 51, who uses the vehicle common server 24 in the vehicle 21, mail information is transmitted from the portable mail server 53 via a radio network N2 to the portable terminal 27.

However, when the user 51 uses the portable terminal 27 to communicate with another user, the vehicle common server 24 makes the saving device 50 save the mail information, which is to be forwarded to the portable terminal 27. In this case, the vehicle common server 24 makes the vehicle user terminal 23 display phrases indicating that the mail information is saved in the saving device 50.

Further, it is also possible for the user 51 to obtain information from the terminal 55 of the communication network N1, provided outside the vehicle 21, by using the vehicle common server 24. This operation is described as follows.

When the user 51 obtains file information of the terminal 55 via the portable terminal 27, the terminal 55 transmits the file information via the portable mail server 53 to the vehicle common server 24. That is, the vehicle common server 24 receives the file information from the terminal 55 via the portable mail server 53. Further, the vehicle common server 24 makes the saving device 50 save the received file information. Thereafter, the vehicle common server 24 reads the file information from the saving device 50, and forwards the file information to the portable terminal 27. That is, since the file information is saved in the saving device 50 for a while, it is possible to save the file information even when there is no space area in a memory (not shown) of the portable terminal 27. Thus, it is possible to forward information without being influenced by memory capacity of the portable terminal 27. Note that, a series of operations, in which the vehicle common server 24 receives file information and makes the saving device save the file information, may be performed before the user 51 uses the vehicle 21.

Further, it is possible for the vehicle common server 24 to transmit information, which is received from the portable terminal 27, to the terminal 54 of the user 52, after the user 51 uses the vehicle user terminal 23. This operation is described as follows.

When the user 51 forwards information to the terminal 54 of the user 52 after using the vehicle user terminal 23, the vehicle common server 24 makes the saving device 50 save the information after performing information communication with the vehicle user terminal 23. Further, when the vehicle common server 24 can perform the information communication with the outside terminal 54, the vehicle common server 24 reads the information, which is to be forwarded, and forwards the information via the server 56 to the terminal 54.

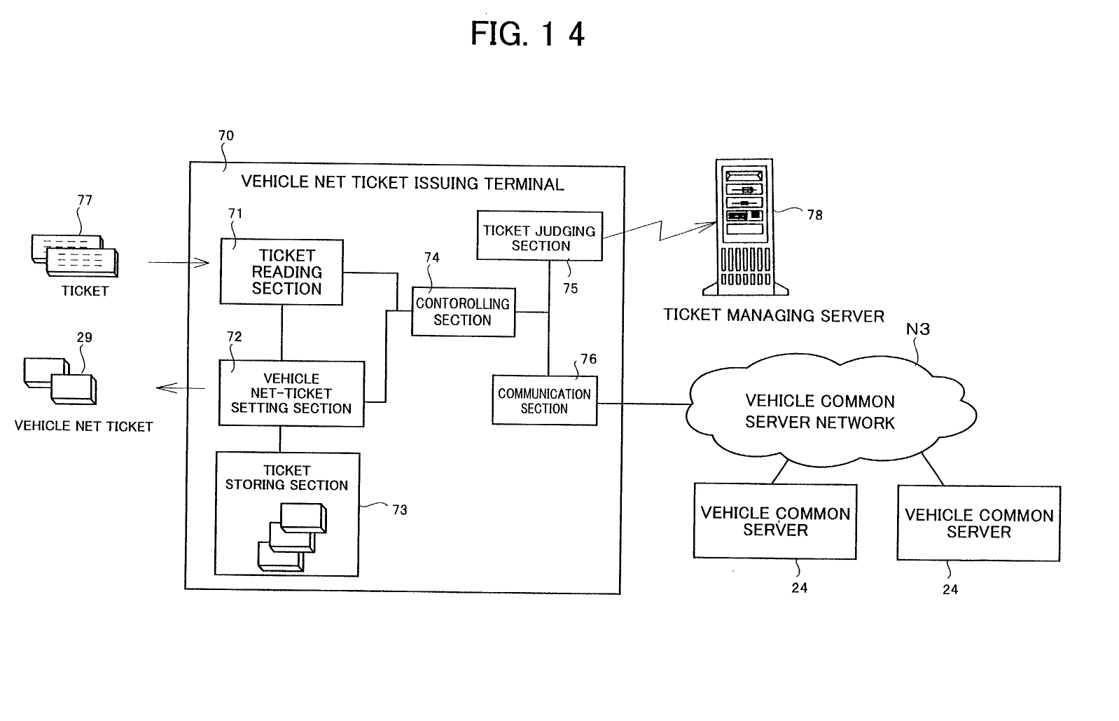

FIG. 14 is a block diagram showing an example of an arrangement of a vehicle net ticket issuing terminal (information recording medium issuing apparatus) 70 according to the present embodiment.

The vehicle net ticket issuing terminal 70 includes a ticket reading section (third reading means) 71, a vehicle net ticket setting section (first recording means) 72, a ticket storing section 73, a controlling section (first reading means, second reading means) 74, a ticket judging section (second checking means) 75, and a communication section 76.

Further, when the vehicle net ticket issuing terminal 70 operates, a ticket (second information recording medium) 77, a vehicle net ticket 29, a ticket managing server 78, and a vehicle common server 24 are used, besides the foregoing main components.

The ticket reading section 71 reads information stored in the ticket 77. The vehicle net ticket setting section 72 stores information in the vehicle net ticket 29. The ticket storing section 73 stores the vehicle net ticket 29, in which information has not been stored yet by the vehicle net ticket setting section 72. The controlling section 74 controls respective sections of the vehicle net ticket issuing terminal 70. The ticket judging section 75 confirms content of information stored in the ticket 77. The communication section 76 communicates with a vehicle common server network N3, a communication network provided in the vehicle, and communicates a using condition (account information) to use the vehicle common server network N3 with the vehicle common server network N3. The ticket 77 is an information recording medium which stores a using condition (third using condition) to use the vehicle 21.

The vehicle net ticket 29 is an information recording medium (ticket) which stores the using condition to use the vehicle common server network N3. The ticket managing server 78 stores information concerning the using condition which was setted in advance, so as to check the using condition stored in the ticket 77.

Next, an operation of the vehicle net ticket issuing terminal 70 is described as follows. First, the ticket reading section 71 reads the using condition (third using condition) recorded in the ticket 77. Further, the controlling section 74 makes the ticket judging section 75 check a using condition (second using condition) stored by the ticket managing server 78 with the using condition stored in the ticket 77. When the using condition stored by the ticket managing server 78 is identical to the using condition stored in the ticket 77, the controlling section 74 requests, via the communication section 76, the vehicle common server 24 to set the account information. Further, the controlling section 74 makes the vehicle net ticket setting section 72 store the account information (first using condition) in the vehicle net ticket taken out from the ticket storing section 73. Thus, the vehicle net ticket issuing terminal 70 issues the vehicle net ticket 29.

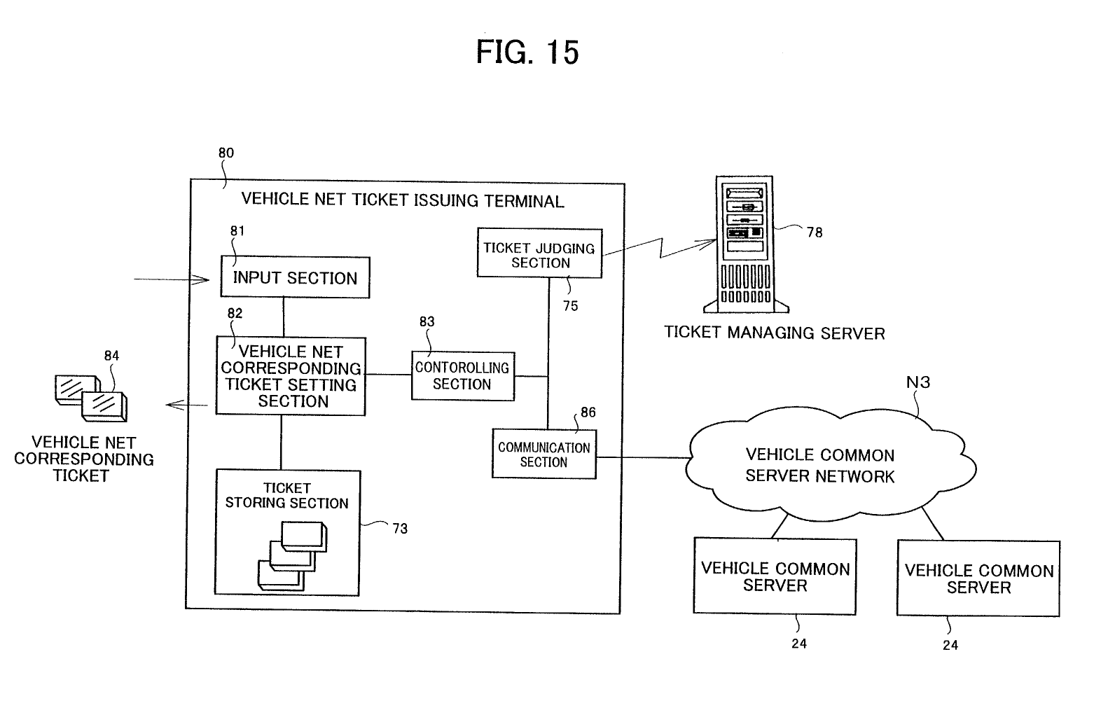

Further, the following is a description of another example of how the vehicle net ticket according to the present embodiment is arranged. FIG. 15 is a block diagram showing another example of an arrangement of the vehicle net ticket issuing terminal which issues a vehicle net corresponding ticket (third information recording medium) 84 as a ticket which stores the account information. In FIG. 15, blocks show main components of the vehicle net ticket issuing terminal 80.

The vehicle net ticket issuing terminal 80 includes: an input section 81; a vehicle net corresponding ticket setting section (second recording means) 82; a ticket storing section 73; a controlling section (first reading means, second reading means, and outputting means) 83; a ticket judging section (second checking means) 75; and a communication section 86.

The input section 81 receives a using condition to use a vehicle inputted by a user of the vehicle. The vehicle net corresponding ticket setting section 82 makes the vehicle net corresponding ticket 84. The controlling section 83 controls respective sections of the vehicle net ticket issuing terminal 80.

When the vehicle net ticket issuing terminal 80 actually operates, a vehicle corresponding ticket 84, a ticket managing server 78, and the vehicle common server 24 are used, besides the foregoing main components. Note that, the vehicle corresponding ticket 84 is an information recording medium which records information and account information to use the vehicle.

Next, an operation of the vehicle net ticket issuing terminal 80 is described as follows. A user of the vehicle inputs a using condition (third using condition) to use the vehicle by operating the input section 81. The controlling section 83 directs the ticket judging section 75 to check the inputted using condition. The ticket judging section 75 checks the using condition inputted by the user of the vehicle with the using condition (the second using condition) which was read from the ticket managing server 78. When the ticket judging section 75 judges that the using condition inputted by the user of the vehicle is identical to the using condition read from the ticket managing server 78, the controlling section 83 requests, via the communication section 86, the vehicle common server 24 to set account information. The setted account information is transmitted via the communication section 86 to the vehicle net corresponding ticket setting section 82.

Further, the controlling section 83 makes the vehicle net corresponding ticket setting section 82 make the vehicle net corresponding ticket 84 in accordance with the using condition recorded in the ticket and the account information (first using condition).

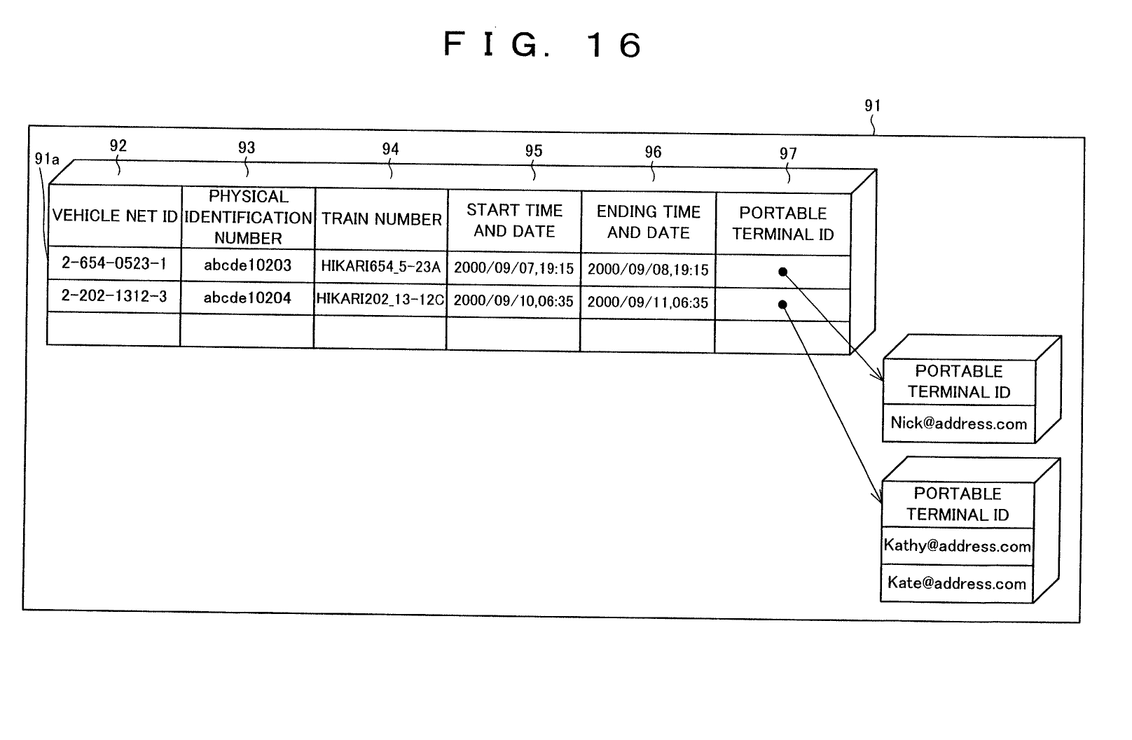

FIG. 16 is a diagram showing an example of content of information stored by the vehicle common server 24. The information shown in FIG. 16 is an example of information (vehicle common server account information 91) concerning a ticket 77 of a train. The vehicle common server account information 91 includes vehicle net ID information 92, physical identification number information 93, train number information 94, start time and date information 95, ending time and date information 96, and portable terminal ID information 97. Note that, the vehicle common server account information 91 is stored in the ticket 77 of a train, the vehicle.

The vehicle net ID information 92 is identification information for identifying the vehicle-provided communication network system provided in the vehicle 21. The physical identification number information 93 is identification information for identifying the vehicle net ticket 29. The train number information 94 is identification information concerning a train and a seat to get on. The start time and date information 95 is identification information concerning the start time and date from which a term of validity begins. The term of validity is a term in which the user can use the vehicle common server 24. The ending time and date information 96 is identification information concerning the ending time and date which is an end of the term of validity. The term of validity is a term in which the user can use the vehicle common server 24. The portable terminal ID information 97 is identification information for identifying the portable terminal 27 when the portable terminal 27 such as a cellular phone is used.

Further, the respective identification information are stored as one record in the ticket 77. For example, the respective information (the vehicle common server account information shown by a mark 91a of FIG. 16) is stored as follows. “2-654-0523-1” is stored as “vehicle net ID”, “abcde10203” is stored as “physical identification number”, “HIKARI 1654_{—}5-23” is stored as “train number”, “2000/09/07, 19:15” is stored as “start time and date”, “2000/09/08, 19:15” is stored as “ending time and date”, “Nick@address.com” is stored as “portable terminal ID” in the ticket 77.

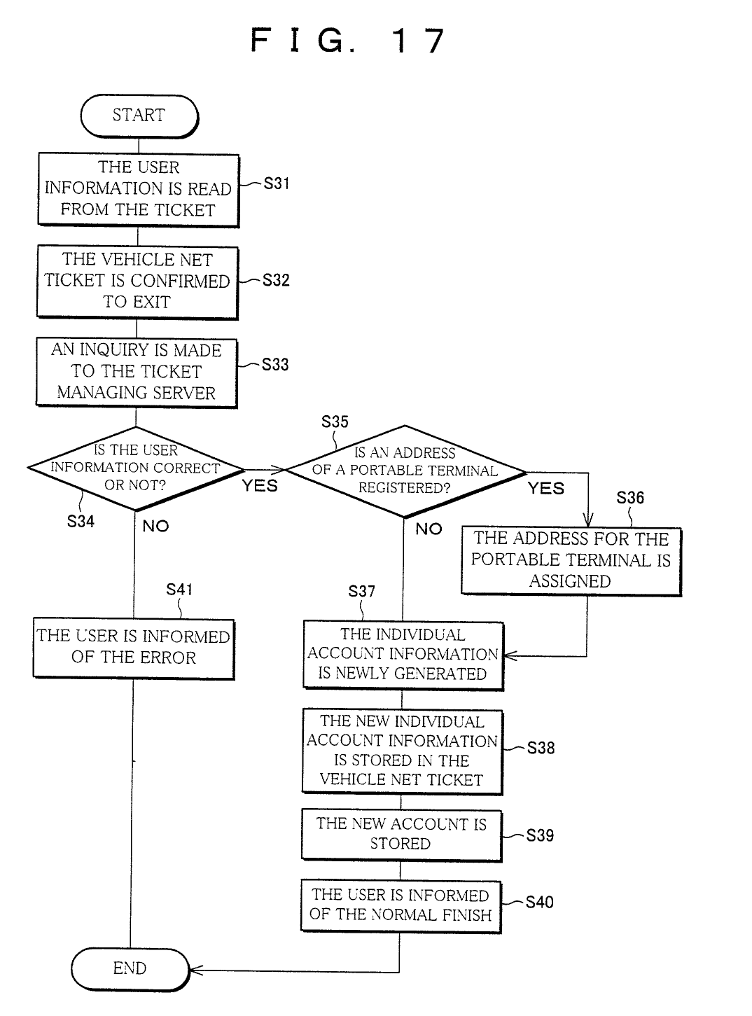

Next, processing steps of the identification information are described as follows with reference to a flow chart of the processing steps shown in FIG. 17.

In S31, the ticket reading section 71 reads vehicle common server account information (user information) 91a from the ticket 77. This operation is described as follows by using a ticket of Sinkansen, a bullet train, as an example.

The following shows a case where a passenger who purchased a reserved seat ticket “2000/09/07, 19:15” of “HIKARI654, the fifth car, seat 23A” purchases a new vehicle net ticket 29, and wants an account of the vehicle common server 24 to be provided. In this case, the vehicle common server 24 provides the account. In order to provide the account, the ticket reading section 71 reads the train number, and the term of validity: from the start time and date information 95 to the ending time and date information 96, from the user information 91a stored in the ticket 77. Concretely, the ticket reading section 71 reads “HIKARI654 the fifth car, seat 23A”, and the term of validity: from “2000/09/07, 19:15” to “2000/09/07, 19:15”, from the user information 71a. Thus, the controlling section 74 can obtain the start time and date information 95 and ending time and date information 96 showing a period in which the vehicle common server 24 can be used.

In S32, the ticket judging section 75 confirms the physical identification number information 93 in accordance with the user information 91a recorded in the ticket 77, and confirms that the ticket 77 exists. Note that, in the vehicle common server account information (user information) 91a shown in FIG. 16, the vehicle net ticket physical identification number information 93 is “abcde10203”.

In S33, the ticket judging section 75 makes an inquiry to the ticket managing server 78, and confirms the user information 71a.

In S34, the ticket judging section 75 checks the user information 91a stored in the ticket 77 with the user information managed by the ticket managing server 78. Here, when the user information 91a is correct, the vehicle net ticket issuing terminal 70 requests, via a display panel etc. (not shown), the user to decide whether an address of the portable terminal 27 is registered or not in S35. The user can register the address of the portable terminal 27 via the vehicle net ticket issuing terminal 70 in the vehicle common server account information 91 as required. Further, when the portable terminal 27 is used, that is, via the portable terminal 27, it is possible to register the address of the portable terminal 27.

In S35, when the user registers the address of the portable terminal 27, the portable terminal ID information 97 of the portable terminal 27 which is used by the user in S36, for example, “Nick@address.com” is registered. Further, in S37, the vehicle net ticket issuing terminal 70 assign the vehicle net ID information 92 for using the vehicle common server 24, for example, “2-654-0523-1”. Thus, the vehicle net ticket issuing terminal 70 makes a new list of the vehicle common server account information 91. At the same time, the address of the portable terminal 27 is registered in the vehicle common server account information 91. Note that, in S35, when the user does not register the address of the portable terminal 27, a process of S37 is performed instead of setting the address of the portable terminal 27.

Next, in S38, the vehicle net ticket setting section 72 records new account information made in S37 in the vehicle net ticket 29. Further, in S39, the vehicle common server 24 stores the newly made account information in the vehicle common server account information 91. Further, the vehicle net ticket issuing terminal 70 informs, via a display panel etc. (not shown), the user that a new account was made normally, and finishes the making process of the new account in S40.

Further, when the user information 91a is not correct in S34, the vehicle net ticket issuing terminal 70 informs, via the display panel etc. (not shown), the user of failing in making the new account, and finishes the making process of the new account in S41.

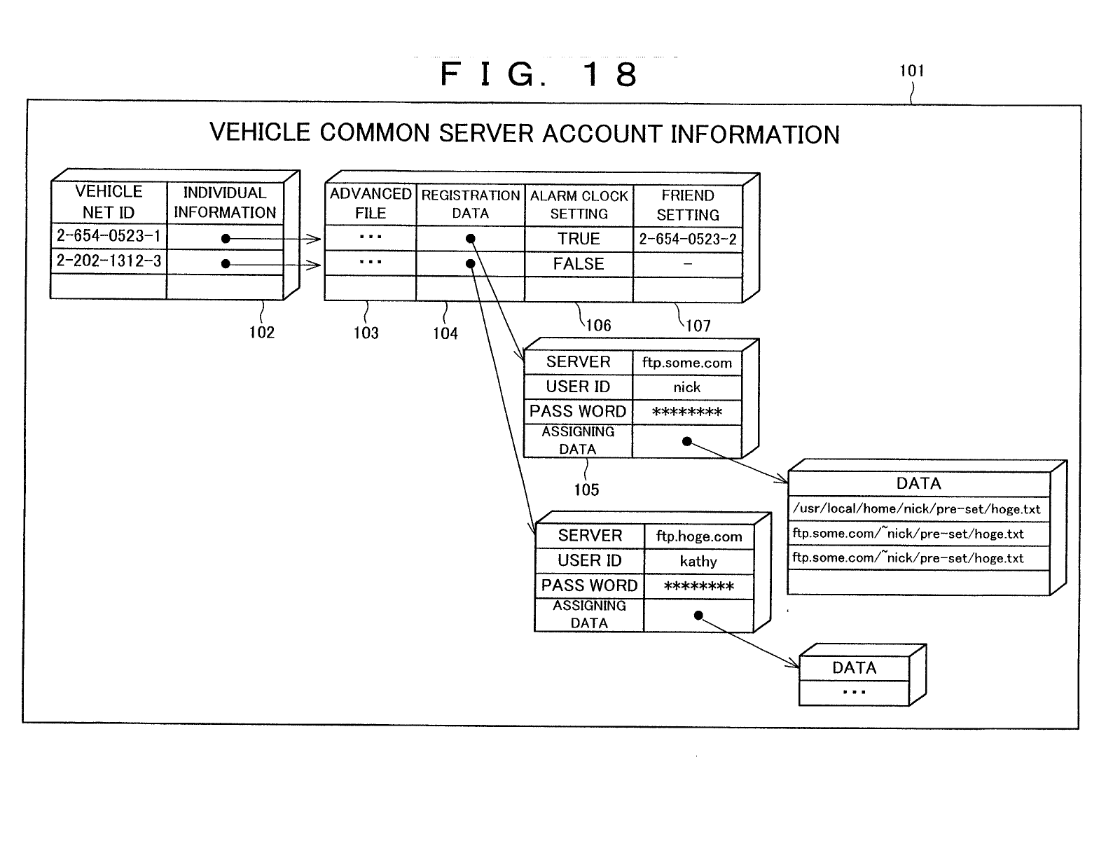

Note that, FIG. 18 is an explanatory drawing showing an example of registration information (vehicle common server account information 71) in a case where the user registers a file used in the vehicle 21 in the vehicle common server 24 in advance before the user uses the vehicle common server 24.

Vehicle server account information 101 includes advanced information 102 which is information saved in advance, an advanced file 103 which stores the advanced information 102, registration information 104 for registering information in the vehicle common server 24, and obtaining information 105 for obtaining the registration information 104 in a case where the registration information 104 exists.

The advanced information 102 includes “vehicle net ID” which is identification information of a communication network of the vehicle, and “individual information” corresponding to the “vehicle net ID”. The advanced file 103 stores information corresponding to information of the advanced information 102. The registration information is information which is stored in the advanced file 103. The obtaining information 105 is made up of “server”, “user ID”, “pass ward”, and “specifying information” which specifies information.

Next, the process for registering information is described as follows.

For example, when a user who obtained the vehicle net ID “2-654-0523-1” registers information in the vehicle common server 24, the user accesses from the radio network N2 outside the vehicle 21 to the vehicle common server 4. When the user specifies the vehicle net ID “2-654-0523-1”, the information is stored in a place “/pre-set/2-654-0523-1” which is a place for storing the advanced information.

After the user uses the vehicle 21, the stored information is read from the storing place, so that it is possible to use the information in the vehicle 21.

Further, when information is to be registered before the vehicle common server 24 is used, the user accesses from an external network to the vehicle common server 24, and inputs the vehicle net ID “2-654-0523-1”, and inputs a server “ftp.some.com” having information which is to be registered, user ID “nick” thereof, and a pass word “******”. Further, information “/usr/local/home/nick/preset/hoge.txt” and aggregation of plural information “ftp.some.com/nick/pre-set/” are specified so as to be registered. Before or after the user begins using the vehicle-provided communication network system, the registered information is forwarded from an information communication apparatus outside the vehicle 21 via the vehicle common server 24 to the inside of the vehicle 21, so that the registered information can be used inside the vehicle 21.

Other than this, the registered information includes alarm clock setting 106, and friend setting 107. The alarm clock setting 106 is to set information concerning whether or not to use service by which transmission of a mail is received according to a transport time. For example, when “TRUE” is setted, the transmission of a mail can be received according to the transport time, and when “FALSE” is set, the transmission of a mail cannot be received.

The friend setting 107 is to set information in a case where the same environment is shared by plural users. For example, when a user of the vehicle net ID “2-654-0523-1” uses the same environment as an environment used by a user whose vehicle net ID is “2-654-0523-2”, “2-654-0523-2” is registered in the friend setting 107, so that the two users can use the same environment.

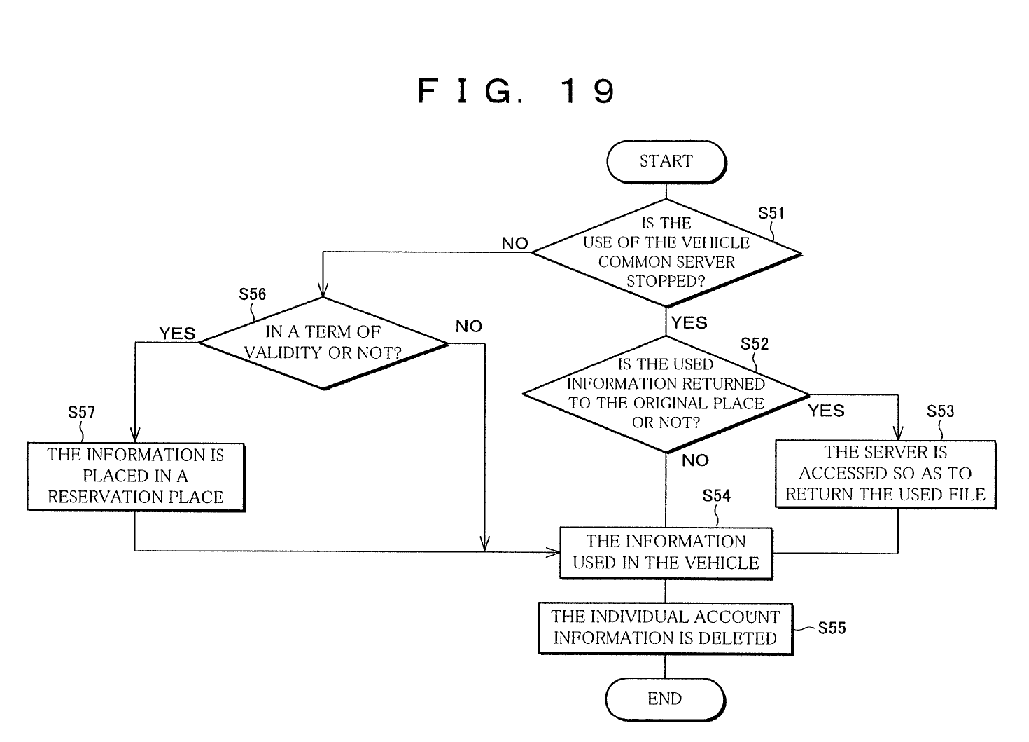

Next, the following describes how the vehicle common server 24 operates when a user finishes using the vehicle common server 24 with reference to FIG. 19. FIG. 19 is a flow chart showing how the vehicle common server 24 operates. Here, a reservation storing place of FIG. 19 is a place in which a user stores information in advance.

First, a controlling section 43 of the vehicle common server 24 confirms whether or not to stop using the vehicle common server 24 (S51) with respect to the vehicle user terminal 23. When a user stops using the vehicle common server 24, the controlling section 43 confirms whether or not to return information which was in use to a server 56 specified by the user with respect to the vehicle user terminal 23 (S52). When the information is to be returned, the controlling section 43 accesses the server 56 so as to return a file which was in use (S53). Thereafter, the controlling section 43 deletes information and individual account setting information which were used in the vehicle common server 24 (S54, S55).

While, when the user is not to stop using the vehicle common server 24 (when judgement “NO” is given in S51), the controlling section 43 confirms whether or not information which is being used is in a term of validity (S56). When the information which is being used is in the term of validity (when judgement “YES” is given in S57), the controlling section 43 places the information, which was used by the user, in a reservation storing place (S57). Thereafter, the controlling section 43 deletes information and individual account setting information which were used in the vehicle common server 24 (S54, S55). Further, when the used information is not in the term of validity (when judgement “NO” is given in S57), the controlling section 43 deletes information and individual account setting information which were used in the vehicle common server 24 (S54, S55).

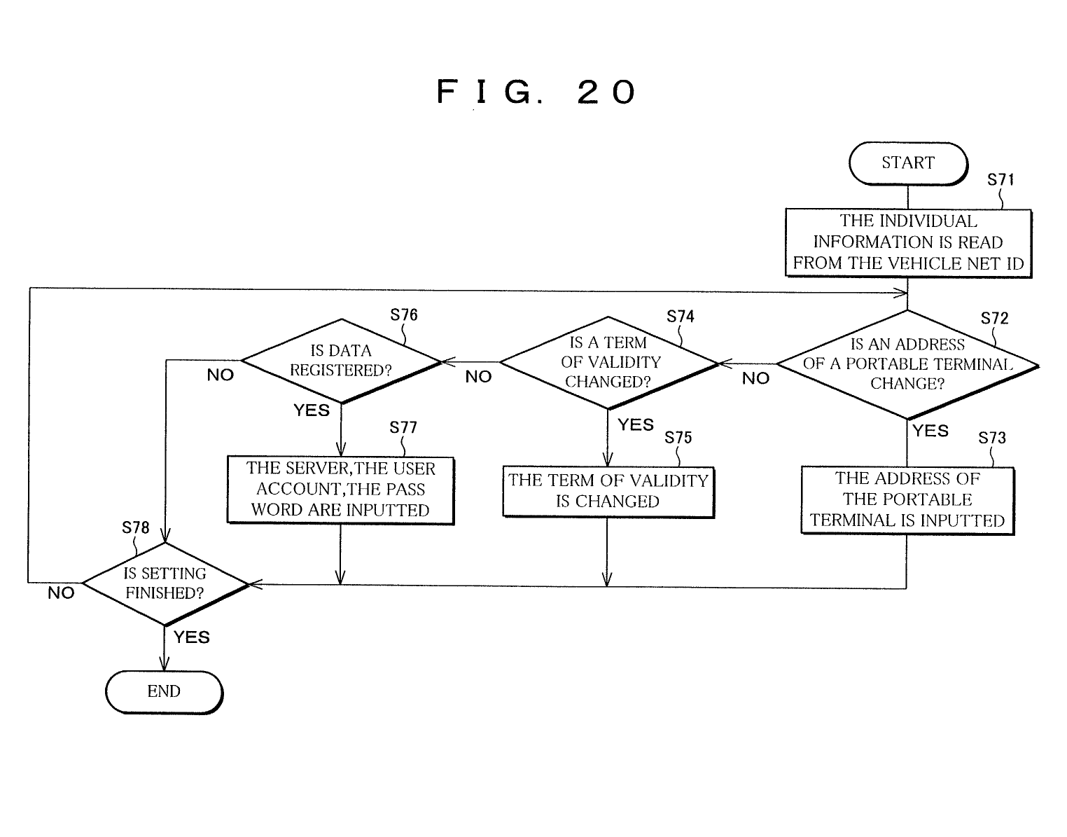

Next, the following describes a process in which a user sets the term of validity with reference to FIG. 20. FIG. 20 is a flow chart showing the process in which a user sets the term of validity. In the present flow chart, changing the term of validity, changing the portable terminal ID, advancement of information, and registration of information are described.

First, the vehicle common server 24 reads user information from the vehicle net ID (S71), and confirms whether or not to change an address of a portable terminal, with respect to the vehicle user terminal 23 (S72). When the address of the portable terminal is to be changed, the user inputs an address of the portable terminal to the vehicle user terminal 23 (S73).

When the address of the portable terminal is not to be changed (when judgement “NO” is given in S72), the vehicle common server 24 confirms whether or not to change the term of validity, with respect to the vehicle user terminal 23 (S74). When the term of validity is to be changed, the user inputs the term of validity to the vehicle user terminal 23. Further, the vehicle common server 24 changes the term of validity as the user inputs (S57). When the term of validity is not to be changed (when judgement “NO” is given in S74), the vehicle common server 24 confirms whether or not to register information which is to be used or information which is to be returned, with respect to the vehicle user terminal 23 (S76). When information is registered, the user inputs a server, a user account, and a pass word with respect to the vehicle user terminal 23 (S77). After these processes, or when information is not to be registered, the vehicle common server 24 confirms whether or not to finish setting (S78). When setting is not to be finished, the vehicle common server 24 begins setting again (S72), and when setting is to be finished, setting is finished.

The present invention is to provide a vehicle-provided communication network system which can provide an information communication environment which is equivalent to an information communication environment outside a vehicle, in a case where information communication is performed in the vehicle.

Further, the present invention is to provide the vehicle-provided communication network system by which information of a communication network system outside the vehicle can be used when a user of the vehicle begins using the vehicle-provided communication network system.

Further, the present invention is to provide the vehicle-provided communication network system by which information can be forwarded to an external communication network system after the user of the vehicle finishes using the vehicle-provided communication network system.

Further, the present invention is to provide the vehicle-provided communication network system by which information can be received from a communication network system outside the vehicle after the user of the vehicle begins using the vehicle-provided communication network system.

Further, the present invention is to provide the vehicle-provided communication network system which can provide a condition in which after the user of the vehicle finishes using an information communication terminal, the next user can use the information communication terminal.

Further, the present invention is to provide the vehicle-provided communication network system by which it is possible to provide a condition in which after the user of the vehicle finishes using a information communication terminal, the next user can use the information communication terminal, and the user of the vehicle can continue to perform a process by an information communication apparatus outside the vehicle.

Further, the present invention is to provide the vehicle-provided communication network system by which information communication can be performed between portable communication terminals after information communication is performed inside the vehicle by using the portable communication terminal.

Further, the present invention is to provide the vehicle-provided communication network system by which the user of the vehicle can set a time to begin information communication.

Further, the present invention is to provide the vehicle-provided communication network system in which information of a using condition to use the vehicle-provided communication network system is deleted after the user of the vehicle finishes using the vehicle-provided communication network system.

Further, the present invention is to provide the vehicle-provided communication network system in which it is possible to set an environment to use the vehicle-provided communication network system.

Further, according to the arrangement, information received from the outside of the vehicle is received by external communication means before the vehicle-provided communication network system is used, and storing means stores the information.

Further, according to the arrangement, after the user finishes using the vehicle-provided communication network system, the external communication means forwards the information to an information communication apparatus outside the vehicle.

Further, according to the arrangement, after the user begins using the vehicle-provided communication network system, the information is received from the outside of the vehicle, and the received information is stored by the storing means.

Further, after the try-out duration of the information recording medium has passed, deleting means deletes the using condition or the identifying information, both of which are required in using the vehicle-provided communication network system, and are stored by the server.

According to the step, the server installed in the vehicle makes a request to electric devices, possessed by the users of the vehicle, for identification information to specify the electric devices. In accordance with the request, the individual information is outputted from the electric device, and is inputted to the server. Thus, the server can specify an electric device, which was allowed to be connected, in accordance with the inputted individual information. Here, the individual information is information, included in each of the electric devices, which is used to specify an electric device.

Further, the server specifies an electric device, so that it is possible to transmit and receive information to and from the specific electric device. Thus, it is possible to build an information communication network between the specific electric device and the server, so that the server can transmit and receive different information to and from every specified electric device. Thus, it is possible to provide various information so as to meet respective requirements of the users.

Further, the information communication network is built between the server and the respective users, so that the user of the vehicle can receive various kinds of service realized in the information communication network. For example, even when the user is in the vehicle, the user can perform communication by using a cellular phone or a PHS, or by using an electric mail or a facsimile etc. in a simple way, as long as the user has the electric devices and the vehicle using right information.

Note that, regardless of whether communication apparatuses are wired or not wired, the information communication network is a communication line network which enables communication apparatuses having at least a communication function to communicate with each other. Thus, according to the inside-vehicle information communication method, the server can be accessed by every communication apparatus of an installation type or a portable type by which communication can be performed via a telephone line, the Internet, or a private line.

According to the foregoing step, the server, installed in the vehicle, can recognize information concerning the use of the vehicle such as transport sections and transport time slots of the respective users, in accordance with the inputted vehicle using right information. The information concerning the use of the vehicle differs according to the users. Thus, the server can specify the individual information which is to be given to the electric device which is allowed to be connected, in accordance with mobile information concerning the transportation of the vehicle which is stored in the server. Note that, the individual information is specified as follows. For example, when the foregoing respective kinds of individual information are stored as a data base in the server, information required by the user is made capable of being read from the data base. Further, the mobile information concerning the transportation of the vehicle is information indicating a schedule of the transportation of the vehicle. The mobile information includes, for example, mobile section information such as a starting point, an intermediate point, and a destination of the vehicle, and time information such as a time when the vehicle passes through or arrives at respective points, and so on.

The individual information given to each electric device which is allowed to be connected is information whose content differs according to requirement and necessity of the user. The individual information includes, for example, time to be taken to get to a station of a destination, distance to the station of the destination, and transfer information etc., and includes also guide information such as sight seeing information of the periphery of the destination or the intermediate points, accommodation information, and weather information.

Thus, the server can provide individual information via the information communication network built in the vehicle to each electric device which is allowed to be connected to the server. Thus, it is possible to provide not only information which is to be shared by all the users in the vehicle, but also individual information whose content differs according to requirement of respective users.

According to the foregoing step, the server transmits the specific individual information to a corresponding electric device based on private information. Thus, the server can specify an electric device to which the individual information is to be transmitted, so that it is possible to avoid such inconvenience that the individual information is transmitted to an electric device which has no relation with the individual information. Note that, in order to specify the electric device, the individual information or the vehicle using right information, both of which are received by the server, can be used.

A time and/or geographical range in which the user can use the server is a time and a transport section in which the user can use the server.

According to the foregoing step, the server, provided in the vehicle, can specify a time and/or geographical range, in which the server can be used, with respect to each of the electric devices allowed to be connected to the server, in accordance with the vehicle using right information that has been inputted and the transportation information concerning the transportation of the vehicle that is stored in the server.

Further, the server performs a specific process with respect to the electric device, when the electric device is to be away from the time and/or geographical range in which the server can be used. Thus, the user can be informed in advance of the left time or the left transport section in which the user can perform the information communication. Thus, the user can finish the information communication before the server becomes incapable of being used, so that it is possible to prevent interruption of the communication due to the disconnection of a line.

According to the step, the server, provided in the vehicle, can specify a time and/or geographical range, in which the server can be used, with respect to each of the electric devices allowed to be connected to the server, in accordance with the vehicle using right information that has been inputted and the transportation information concerning the transportation of the vehicle that is stored in the server.

Further, when the user is to be way from the time and/or geographical range in which the user can use the server, the server transmits information indicating that the user is to be away from the range. Thus, the user can be informed in advance of the left time or the left transport section in which the user can perform the information communication. Thus, the user can finish the information communication before the server becomes incapable of being used, so that it is possible to prevent interruption of the communication due to the disconnection of a line.

An electric settlement, which is a way to perform a settlement via a network in an electric business transaction etc., includes a credit card settlement, a bank account settlement, electric money, an electric check, and so on.

According to the foregoing step, it is possible to build the information communication network between the server and respective electric devices of users, so that the electric settlement can be performed via the electric devices and the server even in the vehicle. Thus, as long as the user has the using right of the vehicle, the user can obtain such an advantage that the regulation charge required in using the vehicle is partially or wholly paid when the vehicle is used, not before the vehicle is used.

Particularly, the step of specifying the time and geographic ranges in which the user can use the server is combined with the foregoing step, so that it is possible to pay the extension fare in accordance with the electric settlement by using an electric device of the user when the user is to go beyond a predetermined station. Thus, a conductor can avoid taking trouble to collect the charges from the users.

Further, from the view point of the user, it is convenient that the user can go beyond a predetermined station freely even when the user has little money with him/her.

Note that, when an electric device is an IC memory card, it is also possible to perform the electric settlement by using the electric device as electric money.

In a case where the vehicle is not operated as scheduled, a deviation may occur in the time and/or geographical range in which the user can use the server.

However, according to the foregoing step, information concerning a present time and a present position is inputted to the server, so that the server can calculate the deviation which occurs in the transport time and/or transport position in which the user can use the server, in accordance with the mobile information, concerning the transportation of the vehicle, which indicates a schedule of the vehicle. Further, the server uses the calculated deviation which occurs in the time and/or geographical range, as rectification amount, so as to rectify the mobile information concerning the transportation of the vehicle stored in the server. Thus, it is possible to provide the individual information which indicates the rectified time and/or geographical range to the user, and it is possible to provide the service required by the user at an appropriate timing.

Further, according to the foregoing arrangement, the managing section requests an electric device, which is allowed to be connected to the server, to output the private information. In response to this, the managing section receives the private information via the communication means. Thus, the managing section can specify the electric device, which is allowed to be connected to the server, in accordance with the received private information.

Thus, the inside-vehicle information communication apparatus can transmit and receive information to and from the specific electric device via the communication means, so that the information communication network can be built in the vehicle. Thus, it is possible for the inside-vehicle information communication apparatus to transmit and receive different information to and from the respective electric devices. Therefore, it is possible to perform various kinds of information providing service according to requirements of the respective users.

Further, according to the foregoing arrangement, the information communication network can be built even in the vehicle, so that it is possible to provide substantially the same service as the information communication service performed outside the vehicle, to the user who uses the vehicle.

Further, according to the foregoing arrangement, the electric devices are obtainable and portable for the respective users, so that it is possible to carry the user's electric device in the vehicle so as to perform the information communication by the electric device. Note that, the portable electric devices includes, for example, a cellular phone, a PHS, and a PDA terminal etc.

Lastly, the foregoing embodiment does not restrict scope of the present invention, and can be varied in many ways within the scope of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An inside-vehicle information communication method, comprising the steps of:
causing a server, provided in a vehicle, to output a request for vehicle using right information, possessed by a user, to an electric device possessed by the user, upon receipt of a request for connection outputted by the electric device;
causing the server to receive the vehicle using right information, outputted from the electric device upon receipt of the request for the vehicle using right information; and
causing the server to confirm whether the electric device has the using right of the vehicle or not, in accordance with the vehicle using right information, and to allow an electric device having the using right to be connected to the server.

2. An inside-vehicle information communication method, comprising the steps of:
causing a server, provided in a vehicle, to output requests for vehicle using right information, possessed by users, to electric devices possessed by the users, upon receipt of requests for connection outputted by the electric devices;
causing the server to receive the vehicle using right information, outputted from the electric devices upon receipt of the requests for the vehicle using right information;
causing the server to confirm whether the electric devices have the using right of the vehicle or not, in accordance with the vehicle using right information, and to allow electric devices having the using right to be connected to the server;
causing the server, provided in the vehicle, to output requests for private information, used to specify the electric devices, to the electric devices allowed to be connected to the server;
causing the server to receive the private information outputted from the electric devices upon receipt of the requests for the private information; and
causing the server to specify the electric devices in accordance with the private information.

3. The method set forth in claim 2, further comprising a step of causing the server, provided in the vehicle, to specify individual information, which is to be given to each of said electric devices allowed to be connected to the server, in accordance with the vehicle using right information that have been inputted and transportation information concerning a transportation of the vehicle that is stored in the server.

4. The method set forth in claim 3, further comprising a step of causing the server, provided in the vehicle, to transmit the individual information, that has been specified, to a corresponding electric device, in accordance with the private information.

5. The method set forth in claim 3, further comprising the steps of:
causing the server, provided in the vehicle, to specify a time and/or geographical range, in which the server can be used, with respect to each of the electric devices allowed to be connected to the server, in accordance with the vehicle using right information that have been inputted and the transportation information concerning the transportation of the vehicle that is stored in the server; and
performing a specific process with respect to the electric device, when the electric device is to be away from the time and/or geographical range in which the server can be used.

6. The method set forth in claim 5, wherein said specific process is a process for transmitting information, which indicates that the time and/or geographical range in which the server can be used is over, to the electric device.

7. The method set forth in claim 3, further comprising the steps of:
causing the server, provided in the vehicle, to specify a time and/or geographical range in which the user can use the vehicle, in accordance with the vehicle using right information that has been inputted; and
causing the server to inform the electric device that the time and/or geographical range is over, when the electric device is to be away from the time and/or geographical range in which the vehicle can be used.

8. The method set forth in claim 2, further comprising a step of causing the server, provided in the vehicle, to perform an electric settlement via the electric device possessed by each user.

9. The method set forth in claim 3, further comprising the steps of:
causing the server, provided in the vehicle, to store information concerning a present time and/or a present position;
causing the server to calculate a deviation which occurs in a transport time and/or a transport position of the vehicle, in accordance with the transportation information concerning the transportation of the vehicle that is stored in the server and the present time and/or the present position that have been inputted; and
causing the server to rectify the transportation information in accordance with the deviation which occurred in the transport time.

10. An inside-vehicle information communication apparatus which is provided in a vehicle so as to transmit and receive information to and from an electric device possessed by a user of the vehicle, comprising:
communication means for transmitting and receiving the information to and from the electric device; and
a managing section (a) for outputting a request for vehicle using right information, possessed by a user, to the electric device possessed by the user, upon receipt of a request for connection outputted from the electric device, (b) for receiving the vehicle using right information via the communication means, (c) for confirming whether the electric device has the using right or not in accordance with the vehicle using right information, and (d) for allowing an electric device having the using right to be connected to the inside-vehicle information communication apparatus.

11. The inside-vehicle information communication apparatus set forth in claim 10, wherein:
said managing section outputs requests for private information to specify the electric device that has been allowed to be connected to the inside-vehicle information communication apparatus, with respect to the electric device, and receives identification information outputted from the electric device upon receipt of the request for the private information, and
the electric device is specified in accordance with the identification information.

12. An inside-vehicle information communication system, comprising:
an inside-vehicle information communication apparatus which is provided in a vehicle so as to transmit and receive information to and from an electric device possessed by a user of the vehicle; and
an electric device, said apparatus including: communication means for transmitting and receiving the information to and from the electric device; and
a managing section (a) for outputting a request for vehicle using right information, possessed by the user, to the electric device possessed by the user, upon receipt of a request for connection outputted from the electric device, (b) for receiving the vehicle using right information via the communication means, (c) for confirming whether the user has the using right or not in accordance with the vehicle using right information, and (d) for allowing an electric device having the using right to be connected to the inside-vehicle information communication apparatus,
said electric device including:
(a) a radio section for transmitting and receiving information to and from communication means of the inside-vehicle information communication apparatus;
(b) a memory section for saving vehicle using right information and private information; and
(c) a controlling section for controlling the radio section and the memory section.

13 An inside-vehicle information communication system, comprising:
a vehicle for carrying users; and
an inside-vehicle information communication apparatus which is provided in a vehicle so as to transmit and receive information to and from an electric device possessed by a user of the vehicle,
said inside-vehicle information communication apparatus including:
communication means for transmitting and receiving the information to and from the electric device; and
a managing section (a) for outputting a request for vehicle using right information, possessed by the user, to the electric device possessed by the user, upon receipt of a request for connection outputted from the electric device, (b) for receiving the vehicle using right information via the communication means, (c) for confirming whether the user has the using right or not in accordance with the vehicle using right information, and (d) for allowing an electric device having the using right to be connected to the inside-vehicle information communication apparatus.

14 The inside-vehicle information communication system set forth in claim 12, further comprising a vehicle for carrying users.

15 The inside-vehicle information communication system set forth in claim 12, wherein said electric device is possessed by each user, and is portable.

16 An inside-vehicle information communication program, wherein a server, provided in a vehicle, is made to execute respective steps of an inside-vehicle information communication method, said method comprising the steps of:
causing a server, provided in a vehicle, to output a request for vehicle using right information, possessed by a user, to an electric device possessed by the user, upon receipt of a request for connection outputted by the electric device;
causing the server to receive the vehicle using right information, outputted from the electric device upon receipt of the request for the vehicle using right information; and
causing the server to confirm whether the electric device has the using right or not, in accordance with the vehicle using right information, and to allow an electric device having the using right to be connected to the server.

17 A recording medium, which stores an inside-vehicle information communication program for making a server, provided in a vehicle, execute respective steps of an inside-vehicle information communication method, said method comprising the steps of:
causing a server, provided in a vehicle, to output a request for vehicle using right information, possessed by a user, to an electric device possessed by the user, upon receipt of a request for connection outputted by the electric device;
causing the server to receive the vehicle using right information, outputted from the electric device upon receipt of the request for the vehicle using right information; and
causing the server to confirm whether the electric device has the using right or not, in accordance with the vehicle using right information, and to allow an electric device having the using right to be connected to the server.

18. A vehicle-provided communication network system, comprising a server, provided in a vehicle, and an information communication terminal, which performs information communication between the server and the information communication terminal, wherein:
the information communication terminal which has (a) reading means for reading a using condition to use the system from a first information recording medium in which the using condition is recorded, and (b) transmitting means for transmitting the using condition, read by the reading means, to the server; and
the server which has (a) memory means for storing the using condition to use the system, (b) a first checking means for checking the using condition, transmitted from the transmitting means, with the using condition, stored in the memory means, and (c) communication controlling means which enables information communication, performed between the server and the information communication terminal, only in a case where the first checking means judges that the both using conditions are identical to each other.

19. A vehicle-provided communication network system which performs information communication between a server, provided in a vehicle, and an information communication terminal, comprising:
the server which has (a) external communication means for performing the information communication with a information communication apparatus outside the vehicle, and (b) memory means for saving identification information of a portable communication terminal connected to the information communication terminal; and
means for performing a relay with respect to communication performed between the information communication apparatus and the portable communication terminal, or receiving information transmitted from the information communication apparatus, instead of the portable communication terminal, in a case where the external communication means receives the information transmitted from the information communication apparatus to the portable communication terminal, the information being the identification information stored in the memory means.

20. The vehicle-provided communication network system set forth in claim 18, wherein:
said server further includes:
external communication means for performing the information communication with the information communication apparatus outside the vehicle; and
storing means for storing information received via the external communication means from the information communication apparatus, before or after the information communication performed between the server and the information communication terminal begins,
said information communication terminal using the information stored in the storing means after the information communication performed between the server and the information communication terminal begins.

21. The vehicle-provided communication network system set forth in claim 18, wherein said server further includes:
external communication means for performing the information communication with the information communication apparatus outside the vehicle; and
means for forwarding information, processed by the information communication terminal, via the external communication means to the information communication apparatus outside the vehicle.

22. The vehicle-provided communication network system set forth in claim 20, wherein said server includes assigning information registration means for registering assigning information to assign information, and obtains information assigned by the assigning information via said external communication means from the information communication apparatus outside the vehicle, after the information communication performed between the server and the information communication terminal begins.

23. An information recording medium issuing apparatus which issues a first recording medium storing a using condition to use a vehicle-provided communication network system in which information communication is performed between a server and a information communication terminal, and sets a first using condition to use the vehicle-provided communication network system and a second using condition to use the vehicle in advance, comprising:
a third reading means for reading a third using condition from a second information recording medium in which the third using condition to use the vehicle is stored; a second reading means for reading the second using condition that has been set; a second checking means for checking the second using condition, read by the second reading means, with the third using condition, read by the third reading means; a first reading means for reading the first using condition that has been set; and first recording means for recording the first using condition in the first recording medium, wherein
said recording means records the first using condition in the first information recording medium, when the second checking means judges that the second using condition is identical to the third using condition.

24. An information recording medium issuing apparatus which issues a third information recording medium recording a using condition to use a vehicle-provided communication network system in which information communication is performed between a server and a information communication terminal, and a using condition to use a vehicle, and sets a first using condition to use the vehicle-provided communication network system and a second using condition to use the vehicle in advance, comprising:
outputting means for outputting a third using condition to use the vehicle; a second reading means for reading the second using condition that has been set; a second checking means for checking the second using condition read by the second reading means with the third using condition outputted by said outputting means; a first reading means for reading the first using condition that has been set; and a second recording means for recording the first using condition, and the second using condition, in a third information recording medium, wherein
the second recording means records the first using condition and the second using condition in the third information recording medium, when the second checking means judges that the second using condition is identical to the third using condition.

25. The vehicle-provided communication network system set forth in claim 18, wherein said server includes deleting means for deleting information, and the deleting means deletes information, that has been processed by the information communication terminal, after the information communication, performed between the server and the information communication terminal, is finished.

26. The vehicle-provided communication network system set forth in claim 25, wherein said server includes external communication means for performing the information communication with a information communication apparatus outside the vehicle, and the external communication means forwards the information, that has been processed by the information communication terminal, to the information communication apparatus outside the vehicle, before the deleting means deletes the information.

27. The vehicle-provided communication network system set forth in claim 19, further comprising switching means for cutting off a connection between the portable communication terminal and the server so as to reconnect said portable communication terminal to another portable communication terminal, wherein said switching means cuts off the connection between the portable communication terminal and the server, after the information communication performed between the server and the portable communication terminal is finished, and reconnects said portable communication terminal to another portable communication terminal.

28. The vehicle-provided communication network system set forth in claim 19, further comprising start setting means for setting start time when the relay begins, wherein said server begins to relay communication performed between the information communication apparatus outside the vehicle and the portable communication terminal at the start time setted by said start setting means.

29. The vehicle-provided communication network system set forth in claim 19, further comprising deleting means for deleting the using condition or the identification information stored in the memory means, wherein the first information recording medium further stores information concerning a term of validity in which the first information recording medium can be used, and the deleting means deletes the using condition or the identification information stored in the memory means after the term of validity has passed.

30. The vehicle-provided communication network system set forth in claim 18, further comprising environment setting means for setting a information communication environment, wherein said environment setting means sets a same information communication environment with respect to plural users of the vehicle, or sets the same information communication environment in accordance with the information recorded in the first information recording medium.

31. A vehicle-provided communication network system, comprising a server, said server including:
communication means for performing communication with a information communication terminal;
memory means for storing a using condition to use the system;
a first checking means for checking a using condition, received via the communication means from the information communication terminal, with the using condition stored in the memory means; and
communication controlling means which enables information communication performed between the information communication terminal and the server only in a case where the first checking means judges that the both using conditions are identical to each other.

32. An inside-vehicle information communication method, comprising the steps of:
causing a server, provided in a vehicle, to receive vehicle using right information outputted from an electric device, possessed by a user of the vehicle, which outputs a request for connection to the server; and
causing the server to confirm whether the electric device has using right of the vehicle or not, in accordance with the vehicle using right information, and to allow an electric device having the using right to be connected to the server.

33. An inside-vehicle information communication apparatus which is provided in a vehicle so as to transmit and receive information to and from an electric device possessed by a user of the vehicle, comprising:
communication means for transmitting and receiving the information to and from the electric device; and
a managing section for (a) receiving vehicle using right information, outputted from the electric device which requests the inside-vehicle information communication apparatus to connect to the electric device, via the communication means, and (b) for confirming whether the electric device has the using right or not in accordance with the vehicle using right information, and (c) for allowing an electric device having the using right to be connected to the inside-vehicle information communication apparatus.
